(19) United States
(12) Patent Application Publication
(10) Pub. No.: US 2012/0135298 A1
(43) Pub. Date: May 31, 2012

(54) NON-AQUEOUS ELECTROLYTE SECONDARY BATTERY AND NON-AQUEOUS ELECTROLYTE

(75) Inventors: Ichiro Yamada, Fukushima (JP); Tadahiko Kubota, Kanagawa (JP)

(73) Assignee: Sony Corporation, Tokyo (JP)

(21) Appl. No.: 13/305,342

(22) Filed: Nov. 28, 2011

(30) Foreign Application Priority Data
Nov. 30, 2010 (JP) 2010-267453

(51) Int. Cl. H01M 10/056; H01M 2/02

(52) U.S. Cl. 429/163; 429/334; 429/303

(57) ABSTRACT

Disclosed is a non-aqueous electrolyte secondary battery including a cathode, an anode, and a non-aqueous electrolyte containing a non-aqueous solvent and an electrolyte salt, wherein the non-aqueous electrolyte contains an orthocarbonate ester compound represented by Formula (1) and cyclic carbonate ester compounds represented by Formulae (2) to (5).

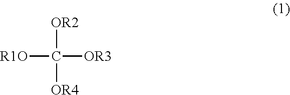

(wherein R1 to R4 each independently represent an alkyl group, an alkyl halide group or an aryl group and R1 to R4 may be joined together to form a ring.)

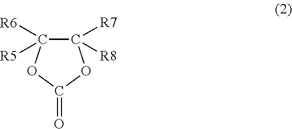

(wherein R5 to R8 each independently represent a hydrogen group, an alkyl group or an alkyl halide group and at least one of R5 to R8 represents a halogen group or an alkyl halide group.)

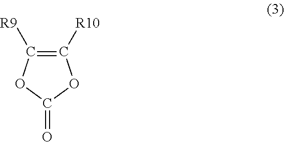

(wherein R9 and R10 each independently represent a hydrogen group, an alkyl group, a halogen group or an alkyl halide group.)

### CROSS REFERENCES TO RELATED APPLICATIONS

The present disclosure claims priority to Japanese Patent Application No. JP 2010-267453 filed on Nov. 30, 2010, the entire disclosure of which is incorporated herein by reference.

### BACKGROUND

The present disclosure relates to a non-aqueous electrolyte secondary battery and a non-aqueous electrolyte. More specifically, the present disclosure relates to a non-aqueous electrolyte secondary battery using a non-aqueous electrolyte containing a non-aqueous solvent and an electrolyte salt.

Recently, portable electrical equipment such as camera-integrated video tape recorders (VTRs), cellular phones or notebook computers have spread widely and miniaturization, lightweightness, and extended lifespans thereof are strongly in demand. Accordingly, as power sources, batteries, in particular, lightweight secondary batteries capable of providing high energy density are being developed.

Of these, secondary batteries (so-called “lithium ion secondary batteries”) which use intercalation and deintercalation of lithium (Li) for charge/discharge reactions exhibit higher energy density than lead batteries or nickel-cadmium batteries and thus are attracting great attention. The lithium ion secondary batteries include a cathode, an anode, and an electrolyte as an ion conduction medium.

In order to improve a variety of performance characteristics of secondary batteries, intense development is being carried out. For example, laminate-type batteries which use a laminate film such as an aluminum laminate film as a package member can increase energy density due to their light weight. However, laminate-type batteries are readily deformed due to swelling of the package member or the like and thus readily cause problems such as liquid leakage due to deformation of the package member, when a flowable electrolyte such as an electrolytic solution is used.

As secondary batteries capable of solving these problems, for example, secondary batteries, such as polymer lithium secondary batteries, using non-flowable electrolytes such as gel electrolytes and complete solid electrolytes, instead of the electrolytic solution, are attracting great attention. These secondary batteries may utilize lightweight and thin materials such as aluminum laminate films as package members, since the materials have low risk of liquid leakage and high safety.

Meanwhile, in accordance with the new trend of high energy density of secondary batteries, ion transfer velocity between a cathode and an anode should be made as high as possible in order to improve charge and discharge characteristics of the batteries. For this reason, it is necessary to facilitate movement of materials through diffusion by increasing the ionic conductivity of the electrolyte or decreasing the viscosity of the electrolyte.

However, when secondary batteries are used over a long period of time, a variety of reactions progress in batteries and battery characteristics are thus deteriorated due to decrease in ionic conductivity of the electrolyte. The deterioration in ionic conductivity causes problems such as degradation in storage characteristics or rate characteristics, as well as battery deformation such as increase in battery thickness when shape-changeable package members such as aluminum laminate films are used.

In this regard, a method for stabilizing the surface of an electrode by previously adding a compound for forming a coating film, called an SEI (solid electrolyte interface; solid electrolyte membrane), on the electrode during charge and discharge for the initial use of batteries, to a solvent was suggested (for example, see Japanese Unexamined Patent Application Publication Nos. 08-045545, 2002-329528, and 10-189042). Based on the configuration of the electrolyte containing the additive, battery characteristics may be improved, but there is a demand for further improvement of performance of an electrolyte in order to realize novel high capacity.

### SUMMARY

The electrolytic solution containing a cyclic compound having an unsaturated group such as vinylene carbonate suggested in Japanese Unexamined Patent Application Publication No. 08-045545 to Japanese Unexamined Patent Application Publication No. 2002-329528 can inhibit side reactions such as decomposition of solvent which occurs on the surface of the anode due to the coating of the surface of the anode. For this reason, deterioration of initial capacity or the like is reduced. Accordingly, in particular, vinylene carbonate is widely used as an electrolytic solution additive.

However, when vinylene carbonate is singly added to the electrolytic solution, the coating film formed by decomposition of vinylene carbonate is decomposed during use of batteries over a long period of time or under the environment of high temperatures due to its low durability, thus disadvantageously causing deterioration in battery characteristics. On the other hand, although vinylene carbonate is added in a predetermined amount or higher to the electrolytic solution, the formed coating film component increases, resistance increases in an initial use stage and battery characteristics are difficult to be thus improved.

These problems become more serious as a reaction area of the anode increases. For example, when the anode is highly densified in order to impart a higher capacity to secondary batteries, the interface of an anode mix which reacts with the electrolytic solution should be ensured. Accordingly, a material having a larger specific surface area is used as an anode active material. For this reason, it is yet more important to inhibit side reactions of the electrolytic solution on the surface of anode.

Accordingly, it is desirable to provide a non-aqueous electrolyte secondary battery and a non-aqueous electrolyte capable of inhibiting resistance increase and thus improving battery characteristics.

According to a first embodiment of the present disclosure, there is provided a non-aqueous electrolyte secondary battery including a cathode, an anode, and a non-aqueous electrolyte containing a non-aqueous solvent and an electrolyte salt, wherein the non-aqueous electrolyte contains an orthocarbonate ester compound represented by Formula (1) and cyclic carbonate ester compounds represented by Formulae (2) to (5).

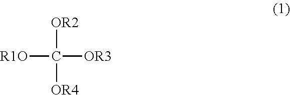

(wherein R1 to R4 each independently represent an alkyl group, an alkyl halide group or an aryl group and R1 to R4 may be joined together to form a ring.)

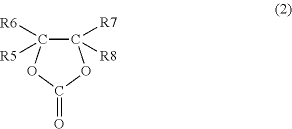

(wherein R5 to R8 each independently represent a hydrogen group, an alkyl group or an alkyl halide group and at least one of R5 to R8 represents a halogen group or an alkyl halide group.)

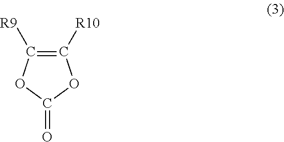

(wherein R9 and R10 each independently represent a hydrogen group, an alkyl group, a halogen group or an alkyl halide group.)

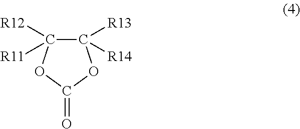

(wherein R11 to R14 each independently represent an alkyl group, a vinyl group or an allyl group and at least one of R11 to R14 represents a vinyl group or an allyl group.)

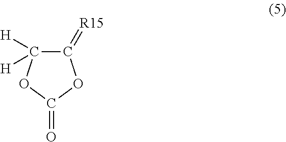

(R15 represents an alkylene group.)

According to a second embodiment of the present disclosure, there is provided a non-aqueous electrolyte containing a non-aqueous solvent, an electrolyte salt, an orthocarbonate ester compound represented by Formula (1), and cyclic carbonate ester compounds represented by Formulae (2) to (5).

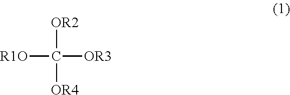

(wherein R1 to R4 each independently represent an alkyl group, an alkyl halide group or an aryl group and R1 to R4 may be joined together to form a ring.)

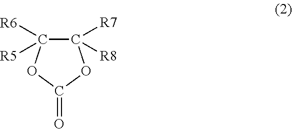

(wherein R5 to R8 each independently represent a hydrogen group, an alkyl group or an alkyl halide group and at least one of R5 to R8 represents a halogen group or an alkyl halide group.)

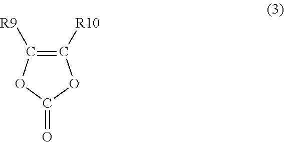

(wherein R9 and R10 each independently represent a hydrogen group, an alkyl group, a halogen group or an alkyl halide group.)

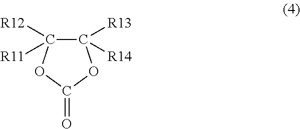

(wherein R11 to R14 each independently represent an alkyl group, a vinyl group or an allyl group and at least one of R11 to R14 represents a vinyl group or an allyl group.)

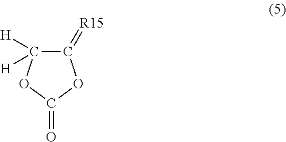

(R15 represents an alkylene group.)

In the First and Second Embodiments, the Non-Aqueous Electrolyte contains the orthocarbonate ester compound represented by Formula (1) as well as the cyclic carbonate ester compounds represented by Formulae (2) to (5). As a result, it is possible to obtain an ideal surface state for the electrode which contacts the non-aqueous electrolyte. That is, the orthocarbonate ester compound represented by Formula (1) acts on the electrode surface and thus improves stability. Accordingly, it is possible to inhibit an increase in resistance during long-term use or storage at high temperatures, which may cause deterioration of ionic conductivity, and thus improve battery characteristics.

The reason for obtaining these superior characteristics is not clear, but is for example thought to be due to the following grounds. That is, when the non-aqueous electrolyte containing the orthocarbonate ester compound represented by Formula (1) is used in a electrochemical device such as a battery, the device exhibits improved chemical stability. More specifically, it is easy to inhibit decomposition of other solvents, or the like, since the orthocarbonate ester compound represented by Formula (1) first self-decomposes. Accordingly, during charge and discharge, the non-aqueous electrolyte is not readily decomposed and deterioration of ionic conductivity is thus inhibited.

Meanwhile, the orthocarbonate ester compound represented by Formula (1) exhibits high reactivity with the anode. For this reason, when this compound is added in an excessive amount or used singly, the compound reacts only with the anode during the initial charge, thus causing generation of gas and deterioration in battery capacity. In this regard, the orthocarbonate ester compound represented by Formula (1) and the cyclic carbonate ester compounds represented by Formulae (2) to (5) may be added to the non-aqueous electrolyte to preliminarily form a stable coating film on the anode and thereby inhibit decomposition of the orthocarbonate ester compound represented by Formula (1) only on the anode during the initial charge.

According to the present disclosure, it is possible to inhibit an increase in resistance and thereby improve battery characteristics.

Additional features and advantages are described herein, and will be apparent from the following Detailed Description and the figures.

### BRIEF DESCRIPTION OF THE FIGURES

FIG. 1 is an exploded perspective view illustrating a configuration example of a non-aqueous electrolyte battery according to an example embodiment of the present disclosure.

FIG. 2 is a cross-sectional view taken along the line II-II of the wound electrode body illustrated in FIG. 1.

FIG. 3 is a cross-sectional view illustrating a configuration example of a non-aqueous electrolyte battery according to an example embodiment of the present disclosure.

FIG. 4 is a partial enlarged view of the wound electrode body illustrated in FIG. 3.

### DETAILED DESCRIPTION

Embodiments of the present application will be described below in detail with reference to the drawings.

In addition, the description will be provided in the following order.

1. First embodiment (electrolyte)
2. Second embodiment (first example of non-aqueous electrolyte battery)
3. Third embodiment (second example of non-aqueous electrolyte battery)
4. Fourth embodiment (third example of non-aqueous electrolyte battery)
5. Other embodiments (modified examples)

### 1. First Embodiment

### Electrolyte

The electrolyte according to the first exemplary embodiment of the present disclosure will be described. The electrolyte according to the first embodiment of the present disclosure is for example an electrolytic solution in the form of a liquid electrolyte. This electrolytic solution contains a non-aqueous solvent, an electrolyte salt, an orthocarbonate ester compound represented by Formula (1) and cyclic carbonate ester compounds represented by Formulae (2) to (5).

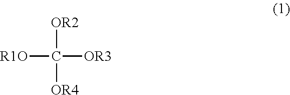

(wherein R1 to R4 each independently represent an alkyl group, an alkyl halide group or an aryl group and R1 to R4 may be joined together to form a ring).

In Formula (1), in a case where R1 to R4 are joined together to form a ring, two of R1 to R4 may be joined together to form one or two R′, each of which constitutes the ring. In this case, R′ represents an alkylene group having 2 or more carbon atoms, an alkylene halide group having 2 or more carbon atoms or a divalent aryl group. In addition, in Formula (1), in a case where R1 to R4 are joined together to form a ring, two of R1 to R4 form one divalent aryl group and one or two of the divalent aryl groups may constitute a ring.

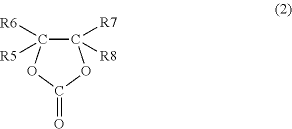

(wherein R5 to R8 each independently represent a hydrogen group, an alkyl group or an alkyl halide group. At least one of R5 to R8 represents a halogen group or an alkyl halide group).

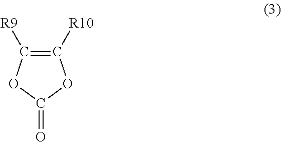

(wherein R9 and R10 each independently represent a hydrogen group, an alkyl group, a halogen group or an alkyl halide group).

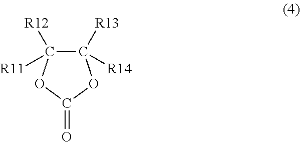

(wherein R11 to R14 each independently represent an alkyl group, a vinyl group or an allyl group. At least one of R11 to R14 represents a vinyl group or an allyl group).

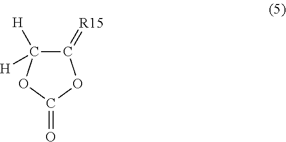

(R15 represents an alkylene group).

### (Orthocarbonate Ester Compound Represented by Formula (1))

The electrolytic solution contains an orthocarbonate ester compound represented by Formula (1). The electrolytic solution may contain one or two of the orthocarbonate ester compounds represented by Formula (1). The electrolytic solution contains the orthocarbonate ester compound represented by Formula (1), thus exhibiting improved chemical stability, when used for electrochemical devices such as batteries. More specifically, the orthocarbonate ester compound self-decomposes first and can thus readily inhibit decomposition of other solvents. Accordingly, the electrolytic solution is not readily decomposed during charge and discharge, thus inhibiting deterioration of ionic conductivity and thereby contributing to improvement of cycle characteristics and energy density of chemical devices such as batteries.

Meanwhile, the orthocarbonate ester compound represented by Formula (1) has high reactivity with an anode and thus reacts with the anode only during the initial charge when added in an excessive amount or used alone, thereby causing gas generation and deterioration in battery capacity. In this regard, the orthocarbonate ester compound represented by Formula (1) is used in combination with the cyclic carbonate ester compounds represented by Formulae (2) to (5) to preliminarily form a coating film on the anode. As a result, it is possible to suppress decomposition of the orthocarbonate ester compound represented by Formula (1) only on the anode during the initial charge.

From a viewpoint that the orthocarbonate ester compound represented by Formula (1) is easily available, it is preferable that in Formula (1), R1 to R4 each independently represent an alkyl group having 1 to 6 carbon atoms or an aryl group. In addition, in Formula (1), more preferably, R1 to R4 each independently represent a methyl group, an ethyl group or a propyl group.

Specifically, the orthocarbonate ester compound represented by Formula (1) is preferably tetramethyl orthocarbonate, tetraethyl orthocarbonate, tetra-n-propyl orthocarbonate, diethylene orthocarbonate, dipropylene orthocarbonate or dicatechol orthocarbonate. The reason is that these orthocarbonate ester compounds are easily available and can exhibit superior effects. The exemplified orthocarbonate ester compound may be used alone or in combination thereof.

The orthocarbonate ester compound represented by Formula (1) is preferably an orthocarbonate ester compound of Formula (1) in which R1 to R4 are joined together to form a ring (hereinafter, arbitrarily referred to as a cyclic orthocarbonate ester compound represented by Formula (1)) in that the compound suppresses gas generation during the initial charge when used for batteries. In addition, among the cyclic orthocarbonate ester compounds represented by Formula (1), orthocarbonate ester compounds having a spiro ring represented by Formula (1A) such as diethylene orthocarbonate, dipropylene orthocarbonate and dicatechol orthocarbonate are more preferred. In addition, from a viewpoint of suppressing gas generation during the initial charge, among the cyclic orthocarbonate ester compounds having a spiro ring represented by Formula (1A), orthocarbonate ester compounds of Formula (1A) in which R16 and R17 each independently represent an alkylene group having 3 or more carbon atoms or an alkylene halide group having 3 or more carbon atoms are more preferred.

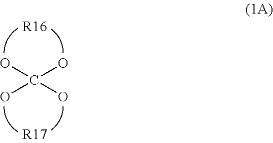

(wherein R16 and R17 each independently represent an alkylene group having 2 or more carbon atoms, an alkylene halide group having 2 or more carbon atoms or a divalent aryl group).

For example, from a viewpoint of suppressing resistance increase, the content of the orthocarbonate ester compound represented by Formula (1) in the electrolyte is preferably 0.01% by mass to 2% by mass, more preferably, 0.1% by mass to 1% by mass, particularly preferably, 0.5% by mass to 1% by mass, based on the total weight of the electrolytic solution.

In addition, the cyclic orthocarbonate ester compound represented by Formula (1) exhibits inhibition of gas generation during the initial charge due to its chemical structure, as compared to the chain orthocarbonate ester compound represented by Formula (1) wherein R1 to R4 in Formula (1) do not form a ring.

Accordingly, from viewpoints of suppressing resistance increase and gas generation during the initial charge, when the orthocarbonate ester compound represented by Formula (1) is a chain orthocarbonate ester compound, the content thereof is preferably 0.01% by mass to 1% by mass, more preferably, 0.5% by mass to 1% by mass. When the content is higher than 1% by mass, gases are readily generated and battery capacity may be deteriorated during the initial charge. In addition, the lower limit of 0.01% by mass is set taking into consideration battery characteristics.

In addition, from viewpoints of suppressing resistance increase and gas generation during the initial charge, when the orthocarbonate ester compound represented by Formula (1) is a cyclic orthocarbonate ester compound represented by Formula (1), the content thereof is a predetermined level or less. That is, the content is preferably 0.01% by mass to 2% by mass, more preferably, 0.01% by mass to 1% by mass, particularly preferably, 0.5% by mass to 1% by mass. When the content is higher than 2% by mass, gases are readily generated and battery capacity is deteriorated during the initial charge. In addition, the lower limit of 0.01% by mass is set taking into consideration battery characteristics.

In addition, Japanese Unexamined Patent Application Publication No. 9-199171 or Japanese Unexamined Patent Application Publication No. 2002-270222 discloses single addition of an orthocarbonate ester compound. For example, Japanese Unexamined Patent Application Publication No. 9-199171 discloses that an orthocarbonate ester compound is incorporated in a non-aqueous electrolytic solution to actively react water contained in the electrolytic solution, which becomes a cause of the deterioration of cycle characteristics, and the orthocarbonate ester compound, aaa thereby improving cycle characteristics. In addition, Japanese Unexamined Patent Application Publication 2002-270222 discloses improvement of stability during overcharge by incorporating an orthoester compound in the non-aqueous electrolytic solution.

Japanese Unexamined Patent Application Publication No. 9-199171 discloses that a sufficiently greater amount of orthocarbonate ester compound is incorporated with respect to the amount of water contained in the non-aqueous electrolytic solution to additionally produce such as an alcohol before charge and discharge and thereby prevent deterioration of cycle characteristics. Accordingly, the specific content of the non-aqueous solvent in the orthocarbonate ester compound is 5% by mass or more of the non-aqueous solvent, that is, greater amount than the optimum content. In addition, Japanese Unexamined Patent Application Publication No. 2002-270222 discloses inhibition of decomposition of the orthoester compound in the non-aqueous electrolytic solution during use of batteries in a normal usage state and improvement of stability during overcharge at a battery voltage of 4.9 V or more.

### (Cyclic Carbonate Ester Compound)

The electrolytic solution contains an orthocarbonate ester compound represented by Formula (1) and cyclic carbonate ester compounds represented by Formulae (2) to (5). When the electrolytic solution contains a cyclic carbonate ester compound represented by Formulae (2) to (5), the cyclic carbonate ester compound represented by Formulae (2) to (5) may be used alone or in combination thereof.

When the cyclic carbonate ester compounds represented by Formulae (2) to (5) are incorporated in the electrolytic solution alone, durability of coating films made of the compounds is deteriorated and resistance increase is difficult to be thus inhibited upon use of batteries over a long period of time or under an environment of high temperatures. On the other hand, when both orthocarbonate ester compounds represented by Formulae (2) to (5) and the orthocarbonate ester compound represented by Formula (1) are incorporated in the electrolytic solution, the orthocarbonate ester compound represented by Formula (1) may act on the surface of an anode and thereby improve stability of coating films. Accordingly, it is possible to inhibit resistance increase upon use over a long period of time and storage at high temperatures, which may cause deterioration of ionic conductivity, and thereby improve battery characteristics.

Examples of the cyclic carbonate ester compound represented by Formula (2) include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-dioxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, and 4-fluoro-4-methyl-1,3-dioxolan-2-one. The compound may be used alone or in combination thereof. Of these, 4-fluoro-1,3-dioxolan-2-one or 4,5-difluoro-1,3-dioxolan-2-one is preferred. The reason is that the compound is easily available and exhibits superior effects.

The cyclic carbonate ester compound represented by Formula (3) is a cyclic carbonate ester compound having an unsaturated bond such as a vinylene carbonate compound. The vinylene carbonate compound is for example vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, or 4-trifluoromethyl-1,3-dioxol-2-one. This compound may be used alone or in combination thereof. Of these, vinylene carbonate is preferred. The reason is that the compound is easily available and exhibits superior effects.

The cyclic carbonate ester compound represented by Formula (4) is a cyclic carbonate ester compound having an unsaturated bond such as a vinyl ethylene carbonate compound. The vinyl ethylene carbonate compound is for example vinyl ethylene carbonate (4-vinyl-1,3-dioxolan-2-one), 4-methyl-4-vinyl-1,3-dioxolan-2-one, 4-ethyl-4-vinyl-1,3-dioxolan-2-one, 4-n-propyl-4-vinyl-1,3-dioxolan-2-one, 5-methyl-4-vinyl-1,3-dioxolan-2-one, 4,4-divinyl-1,3-dioxolan-2-one, or 4,5-divinyl-1,3-dioxolan-2-one. This compound may be used alone or in combination thereof. Of these, vinyl ethylene carbonate is preferred. The reason is that the compound is easily available and exhibits superior effects. In Formula (4), R11 to R14 may represent a vinyl group, an allyl group, or a combination of a vinyl group and an allyl group.

The cyclic carbonate ester compound represented by Formula (5) is a cyclic carbonate ester compound having an unsaturated bond such as a methylene ethylene carbonate compound. Examples of the methylene ethylene carbonate compound include 4-methylene-1,3-dioxolan-2-one, 4,4-dimethyl-5-methylene-1,3-dioxolan-2-one, and 4,4-diethyl-5-methylene-1,3-dioxolan-2-one. This compound may be used alone or in combination thereof. The methylene ethylene compound may have one methylene group (compound represented by Formula (5)) or have two methylene groups.

In addition, the cyclic carbonate ester compound having an unsaturated bond may be a catechol carbonate having a benzene ring, in addition to the compounds represented by Formulae (3) to (5).

### (Content)

The content of the cyclic carbonate ester compounds represented by Formulae (2) to (5) in the electrolytic solution is 0.1% by mass to 40% by mass, preferably, 0.5% by mass to 5% by mass, more preferably, 1% by mass to 3% by mass, based on the total amount of the electrolytic solution. When the content is higher than 5% by mass, resistance readily increases due to decomposition upon use over a long period of time or under the environment of high temperatures. When the content is lower than 0.5% by mass, generation of gas during the initial charge and discharge is difficult to be sufficiently inhibited.

### (Non-Aqueous Solvent)

Examples of the non-aqueous solvent include ethylene carbonate (EC), propylene carbonate (PC), butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. The reason is that superior battery capacity, superior cycle characteristics and superior storage characteristics can be imparted to electrochemical devices including the electrolyte such as batteries. This compound may be used alone or in combination thereof.

Of these, the non-aqueous solvent is preferably at least one selected from the group consisting of ethylene carbonate, propylene carbonate, dimethyl carbonate, diethyl carbonate and ethyl methyl carbonate. The reason is that the compound can exhibit superior effects. In this case, a combination of a high viscosity (high dielectric constant) solvent (for example, specific dielectric constant ∈≧30) such as ethylene carbonate and propylene carbonate and a low viscosity solvent (for example, viscosityl mPa·s) such as dimethyl carbonate, ethyl methyl carbonate, and diethyl carbonate is more preferred. The reason is that dissociation properties of the electrolyte salt and ion mobility are improved and superior effects can be thus obtained.

### (Electrolyte Salt)

The electrolyte salt contains, for example, one or more light metal salts such as a lithium salt. Examples of lithium salts include lithium hexafluorophosphate (LiPF₆), lithium tetrafluoroborate (LiBF₄), lithium perchlorate, lithium hexafluoroarsenate, lithium tetraphenylborate (LiB(C₆H₅)₄), lithium methanesulfonate (LiCH₃SO₃), lithium trifluoromethane sulfonate (LiCF₃SO₃), and lithium tetrachloroaluminate (LiAlCl₄), dilithium hexafluorosilicate (Li₂SiF₆), lithium chloride (LiCl), and lithium bromide (LiBr). Of these, at least one selected from the group consisting of lithium hexafluorophosphate, lithium tetrafluoroborate, lithium perchlorate and lithium hexafluoroarsenate is preferred, and lithium hexafluorophosphate is more preferred. The reason is that the compound reduces the resistance of the electrolyte.

The electrolyte according to the first embodiment of the present disclosure may be a flowable electrolyte such as electrolyte solution as well as a solid or semisolid electrolyte non-flowable electrolyte. The non-flowable electrolyte is for example a semisolid non-flowable electrolyte such as gel electrolyte, obtained by holding the electrolyte solution in a polymer compound and thereby not fluidizing the electrolyte solution. In addition, the non-flowable electrolyte may be a solid non-flowable electrolyte, such as a complete solid electrolyte, obtained by forming a solid having ion conductivity using a polymer compound and an electrolyte salt.

The amount of electrolyte used for the semisolid non-flowable electrolyte is 50% by mass to 99% by mass, based on the total amount of the non-flowable electrolyte. When the amount used is excessively high, storage and conservation of the electrolytic solution are difficult and the solution is readily leaked, and when the amount used is excessively low, charge/discharge efficiency or capacity may be insufficient.

Examples of the polymer compound which holds the electrolytic solution in the semisolid non-flowable electrolyte include alkylene oxide polymer compounds containing alkylene oxide units, fluorine polymer compounds such as polyvinylidene fluoride or vinylidene fluoride-hexafluoropropylene copolymers, and a variety of polymer compounds capable of holding the electrolytic solution. The concentration of the electrolytic solution in the polymer compound is commonly 0.1% by mass to 30% by mass, based on the molecular weight of the polymer compound used. When the concentration of the polymer compound is excessively low, the holding property of the electrolytic solution is deteriorated, and problems such as flowability and liquid leakage may thus occur. In addition, when the concentration of polymer compound is excessively high, difficulties associated with processes due to excessively high viscosity occur and decrease in ratio of the electrolytic solution, deterioration of ionic conductivity and battery characteristics such as rate characteristics may occur.

Examples of methods for forming a semisolid non-flowable electrolyte include dipping the electrolytic solution in a polymer compound such as a polyalkylene oxide isocyanate cross-linker and non-fluidization of semisolid electrolyte precursors. Preferably, the non-fluidization of semisolid electrolyte precursors includes (1) polymerizing such as UV curing or thermally curing an electrolytic solution containing a polymeric gelling agent, or (2) dissolving the polymer compound in an electrolytic solution at a high temperature and cooling the resulting solution to room temperature.

In the method (1) using the electrolytic solution containing a polymeric gelling agent, examples of the polymeric gelling agent include compounds having an unsaturated double bond such as an acryloyl group, a methacryloyl group, a vinyl group and an allyl group. Specifically, examples of the polymeric gelling agent include acrylic acid, methyl acrylate, ethyl acrylate, ethoxyethyl acrylate, methoxyethyl acrylate, ethoxyethoxyethyl acrylate, polyethylene glycol monoacrylate, ethoxyethyl methacrylate, methoxyethyl methacrylate, ethoxyethoxyethyl methacrylate, polyethylene glycol monomethacrylate, N,N-diethylaminoethyl acrylate, N,N-dimethylaminoethyl acrylate, glycidyl acrylate, allyl acrylate, acrylonitrile, N-vinylpyrrolidone, diethylene glycol diacrylate, triethylene glycol diacrylate, tetraethylene glycol diacrylate, polyethylene glycol diacrylate, diethylene glycol dimethacrylate, triethylene glycol dimethacrylate, tetraethylene glycol dimethacrylate, polyethylene glycol dimethacrylate, polyalkylene glycol diacrylate, polyalkylene glycol dimethacrylate, and trifunctional monomers such as trimethylolpropane alkoxylate triacrylate and pentaerythritol alkoxylate triacrylate, and tetrafunctional or multi-functional monomers such as pentaerythritol alkoxylate tetraacrylate and ditrimethylolpropane alkoxylate tetraacrylate. Of these, an oxyalkylene glycol compound having an acryloyl group or a methacryloyl group is preferred.

Meanwhile, in the method (2) for forming a semisolid non-flowable electrolyte by dissolving the polymer compound in an electrolytic solution at a high temperature and cooling the resulting solution to room temperature, any polymer compound may be used as long as it forms a gel with the electrolytic solution and is stably used as a battery material. Specifically, examples of the polymer compound include polymers having a ring such as polyvinylpyridine and poly-N-vinylpyrrolidone. In addition, examples of the polymer compound include acrylate derivative polymers such as polymethylmethacrylate, polyethylmethacrylate, polybutylmethacrylate, polymethylacrylate, polyethylacrylate, polyacrylic acid, polymethacrylic acid and polyacrylamide. In addition, examples of the polymer compound include fluorine resins such as polyvinyl fluoride and polyvinylidene fluoride. Examples of the polymer compound include CN group-containing polymers such as polyacrylonitrile and polyvinylidene cyanide. Examples of the polymer compound include polyvinyl alcohol polymers such as polyvinyl acetate and polyvinyl alcohol. Examples of the polymer compound include halogen-containing polymers such as polyvinyl chloride and polyvinylidene chloride. In addition, mixtures, modified compounds, derivatives, random copolymers, alternating copolymers, graft copolymers and block copolymers of the polymer compounds may be used. The reason is that the weight average molecular weight of these polymer compounds is preferably within a range of 10,000 to 5,000,000. When the molecular weight is low, gel formation is difficult and when the molecular weight is high, the viscosity is excessively high and handling is difficult.

### 2. Second embodiment

### Configuration of Non-Aqueous Electrolyte Battery

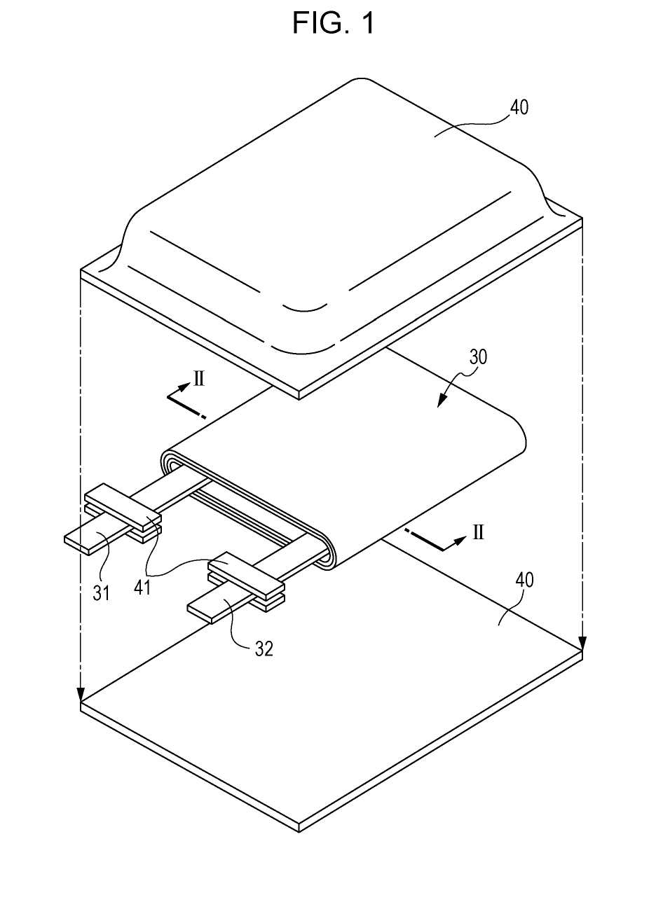

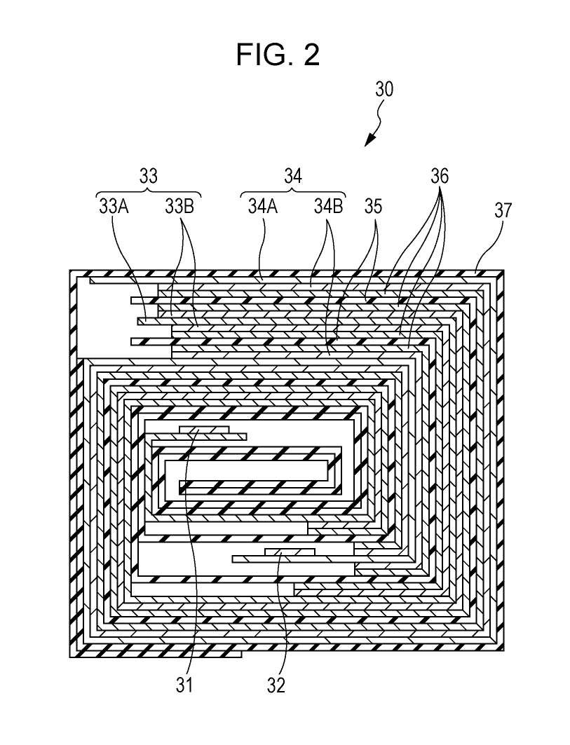

The non-aqueous electrolyte battery according to a second embodiment of this disclosure will be described. FIG. 1 is an exploded perspective view illustrating a configuration of a non-aqueous electrolyte battery according to the second embodiment of the present disclosure. FIG. 2 is an enlarged view taken along the line II-II of a wound electrode body 30 illustrated in FIG. 1. This non-aqueous electrolyte battery is for example a chargeable and dischargeable non-aqueous electrolyte secondary battery.

This non-aqueous electrolyte battery has a structure in which a wound electrode body 30 is housed in a film-shaped package member 40 provided with a cathode lead 31 and an anode lead 32. The battery structure using the film-shaped package member 40 is called a “laminate-type” structure.

For example, the cathode lead 31 and the anode lead 32 extend in one direction from the inside of the package member 40 toward the outside. The cathode lead 31 is for example composed of a metal material such as aluminum and the anode lead 32 is for example composed of a metal material such as copper, nickel or stainless steel. This metal material for example has the shape of a thin plate or mesh.

The package member 40 is for example composed of an aluminum laminate film including a nylon film, an aluminum foil and a polyethylene film adhered to one another in this order. For example, the package member 40 has a structure in which outer edges of two rectangular aluminum laminate films are fused or adhered to each other through an adhesive such that a polyethylene film faces the wound electrode body 30.

An adhesive film 41 to protect against incorporation of outside air is inserted between the package member 40, and the cathode lead 31 and the anode lead 32. The adhesive film 41 is made of a material having contact characteristics with respect to the cathode lead 31 and the anode lead 32. Examples of the material include a polyolefin resin such as polyethylene, polypropylene, modified polyethylene, and modified polypropylene.

In addition, the package member 40 may be made of a laminated film having other laminated structures, a polymer film such as polypropylene, or a metal film, instead of the aluminum laminated film.

FIG. 2 is a cross-sectional view taken along the line II-II of the wound electrode body 30 illustrated in FIG. 1. The wound electrode body 30 includes a cathode 33 and an anode 34 which are stacked and wound through a separator 35 and an electrolyte 36 and the outermost edge thereof is protected with a protective tape 37.

### (Cathode)

The cathode 33 for example has a structure in which a cathode active material layer 33B is formed on both surfaces of a cathode current collector 33A having the pair of surfaces. The cathode active material layer 33B may be formed on one surface of the cathode current collector 33A. The cathode current collector 33A may for example utilize a metal foil such as an aluminum (Al) foil, a nickel (Ni) foil or a stainless steel (SUS) foil.

The cathode active material layer 33B contains, as a cathode active material, one or more cathode materials which enable intercalation and deintercalation of lithium and may optionally contain other materials such as binders or conductive agents.

Examples of cathode materials which enable intercalation and deintercalation of lithium include lithium cobalt composite oxide (LiₓCoO₂ (0.05≦x≦0.10)), lithium nickel composite oxide (LiₓNiO₂ (0.05≦x≦1.10)), lithium nickel cobalt composite oxide (LiₓNi_{1-z}CO_{z}O₂ (0.05≦x≦1.10, 0<z<1)), lithium nickel cobalt manganese composite oxide (LiₓNi_{(1-v-w)}COᵥMn_{w}O₂ (0.05≦x≦1.10, 0<v<1, 0<w<1, v+w<1)), or lithium manganese composite oxide (LiMn₂O₄) or lithium manganese nickel composite oxide (LiMn₂₋ₜNiₜO₄ (0<t<2)) having a spinel-type structure. Of these, cobalt-containing composite oxide is preferred. The reason is that this oxide can exhibit high capacity as well as superior cycle characteristics. In addition, examples of phosphate compounds containing lithium and a transition metal element include lithium iron phosphate compounds (LiFePO₄) and lithium iron manganese phosphate compounds (LiFe₁₋ᵤMnᵤPO₄ (0<u<1)), LiₓFe_{1-y}M2_{y}PO₄ (wherein M2 is for example at least one selected from the group consisting of manganese (Mn), nickel (Ni), cobalt (Co), zinc (Zn), magnesium (Mg) and x satisfies 0.9≦x≦1.1).

Examples of other cathode materials which enable intercalation and deintercalation of lithium include oxides such as titanium oxide, vanadium oxide or manganese dioxide, disulfides such as titanium disulfide and molybdenum sulfide, chalcogenides such as niobium selenide, and conductive polymers such as sulfur, polyaniline, and polythiophene. Other cathode materials which enable intercalation and deintercalation of lithium may be used. In addition, the series of cathode materials may be used in combination of two or more types.

### (Binder)

Examples of the binder include synthetic rubbers such as styrene butadiene rubbers, fluorinated rubbers and ethylene propylene dienes and polymer materials such as polyvinylidene fluoride and cellulose such as carboxymethyl cellulose. The binder may be used alone or in combination of two or more types thereof.

### (Conductive Agent)

Examples of the conductive agent include carbon materials such as graphite and carbon black. The conductive agent may be used alone or in combination thereof.

### (Anode)

The anode 34 has a structure in which an anode active material layer 34B is formed on both surfaces of an anode current collector 34A having a pair of surfaces. The anode active material layer 34B may be formed on one surface of the anode current collector 34A. The anode current collector 34A is for example a metal foil such as a copper (Cu) foil, a nickel foil or a stainless steel foil.

The anode active material layer 34B contains, as an anode active material, one or more anode materials which enable intercalation and deintercalation of lithium and may optionally contain other materials such as binders or conductive agents. The charge capacity of the anode material which enables intercalation and deintercalation of lithium is preferably higher than the discharge capacity of the cathode 33. In addition, details of binder and conductive agent are the same as those of the cathode 33.

Examples of cathode materials which enable intercalation and deintercalation of lithium include graphite in which the spacing of (002) plane is 0.34 nm or less and carbon materials such as non-graphitizable carbon, graphitizable carbon, pyrolytic carbon, coke, glassy carbon fibers, an organic polymer compound fired materials, activated carbon, and carbon black in which the spacing of (002) plane is 0.37 nm or more. Of these, the coke includes pitch coke, needle coke, and petroleum coke. The organic polymer compound fired material refers to a substance which is obtained by firing and carbonizing a phenol resin, a furan resin or the like at an appropriate temperature and some thereof is classified into non-graphitizable carbon or graphitizable carbon. In addition, examples of the polymer material include polyacetylene, polypyrrole and the like. These carbon materials are preferred in that they undergo little deformation of crystal structures during charge and discharge and obtain high charge/discharge capacity as well as good cycle characteristics. In particular, graphite is preferred from viewpoints of having a high electrochemical equivalent and obtaining a high energy density.

The anode active material is preferably a carbon material having a BET specific surface area of 0.8 m²/g to 4.0 m²/g. The carbon material exhibits superior electrolyte retention capacity and facilitates intercalation and deintercalation of lithium ions on the electrode surface, thus obtaining superior characteristics.

When the specific surface area of the carbon material is lower than the range defined above, a holding capacity of electrolytic solution is decreased and an area where the carbon material reacts with the electrolytic solution is decreased in a case where the anode is highly densified, thus causing deterioration of load characteristics. On the other hand, when the specific surface area is higher than the range defined above, the decomposition reaction of electrolytic solution is facilitated and generation of gas thus increases.

Methods for obtaining the carbon material include use of artificial graphite having a relatively low specific surface area, use of natural graphite having high specific surface area and surface-modification of natural graphite to reduce the specific surface area. Examples of the surface modification method include thermal treatment of a carbon material, application of mechanical energy, and coating the surface of carbon material with low-crystalline carbon.

A method for manufacturing an anode is as follows. For example, an anode material is mixed with a binder to prepare an anode mix and the anode mix is dispersed in a solvent such as N-methyl-2-pyrrolidone to prepare an anode mix slurry. Then, the anode mix slurry is applied to an anode current collector, dried and molded by compression to form an anode active material layer and thereby manufacture an anode. At this time, an applied pressure is adjusted to impart the desired density to the anode mix layer. The density of the anode mix layer is preferably 1.50 g/cc to 1.80 g/cc, more preferably, 1.55 g/cc to 1.75 g/cc. When the density of the anode mix layer is excessively low, the volumic amount of active material is low and conductivity is deteriorated by pores in the anode and capacity is thus deteriorated. In addition, when the density of the anode mix layer is excessively high, a holding capacity of electrolytic solution in the electrode is deteriorated and movement of lithium ions is thus suppressed on the electrode interface.

In addition to the aforementioned carbon materials, examples of anode materials which enable intercalation and deintercalation of lithium include materials which contain, as a constituent component, at least one of metal elements and metalloid elements which enable intercalation and deintercalation of lithium. The reason is that these materials can realize high energy density. These anode materials may be an alloy or be compound of metal elements or metalloid elements and may at least partially have one or two phases thereof. In addition, in the present disclosure, the term “alloy” includes an alloy composed of two or more metal elements as well as an alloy composed of one or more metal element and one or more metalloid elements. In addition, “alloy” may contain a nonmetal element. The texture of the alloy includes a solid solution, a eutectic crystal (eutectic mixture), an intermetallic compound, and a texture in which two or more thereof coexist.

Examples of the metal elements or the metalloid elements include metal elements or metalloid elements which are capable of forming an alloy with lithium. Specifically, examples of the metal elements or the metalloid elements include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), platinum (Pt) and the like. Of these, at least one of silicon and tin is preferred and silicon is more preferred. The reason is that silicon and tin have high ability to intercalate and deintercalate lithium and thus are able to provide a high energy density.

Examples of the anode material containing at least one of silicon and tin include single substances, alloys, or compounds of silicon, single substances, alloys, or compounds of silicon of tin, and materials having one or more phases thereof at least in part.

Examples of alloys of silicon include an alloy which contains, as a secondary element other than silicon, at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include an alloy which contains, as a secondary element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of tin or silicon include tin or silicon compounds containing oxygen (O) or carbon (C) and tin or silicon compounds containing the secondary element in addition to tin (Sn) or silicon (Si).

In addition, examples of anode materials which enable intercalation and deintercalation of lithium include other metal compounds or polymer materials. Examples of other metal compounds include oxides such as MnO₂, V₂O₅ and V₆O₁₃, sulfides such as NiS and MoS, lithium nitride such as LiN₃, and the like. Examples of the polymer materials include polyacetylene, polyaniline, polypyrrole and the like. In addition, the anode materials which enable intercalation and deintercalation of lithium may be other than the aforementioned anode materials. In addition, the anode material may be used in combination thereof.

### (Electrolyte)

The electrolyte 36 is for example a semisolid non-flowable electrolyte such as a gel electrolyte, as described in the first embodiment, obtained by holding the electrolyte solution in a polymer compound and thereby fluidizing the electrolyte solution. Details of the electrolyte and polymer compound are the same as in the first embodiment and a detailed explanation is thus omitted.

### (Separator)

The separator 35 separates the cathode 33 from the anode 34, prevents short circuit of current caused by contact with the cathode and allows passage of lithium ions. For example, the separator 35 is made of a porous membrane made of a polyolefin material such as polyethylene (PE) or polypropylene (PP). The separator has a laminate structure including two or more porous membranes. In addition, the separator may have a structure in which a porous resin layer such as polyvinylidene fluoride (PVdF) or polytetrafluoroethylene (PTFE) is formed on a porous membrane made of a polyolefin material.

In addition, an electrolyte may be impregnated in the separator 35 which uses a combination of a porous polyolefin film and a semisolid non-flowable electrolyte. That is, the separator 35 whose surface is coated with a polymer compound to hold the electrolytic solution may be used. By using such a separator 35, in a case where an electrolytic solution is impregnated in the separator 35 in the subsequent battery manufacturing process, the electrolyte 36 is formed on the surface of the separator 35. The electrolyte contains the orthocarbonate ester compound represented by Formula (1) and cyclic carbonate ester compounds represented by Formulae (2) to (5). In addition, in the present disclosure, the non-flowable electrolyte may be used as a layer to separate the cathode 33 from the anode 34 without using the separator 35.

### (Method for Manufacturing Non-Aqueous Electrolyte Battery)

The non-aqueous electrolyte battery is for example manufactured in accordance with the following three manufacturing methods (first to third manufacturing method).

### (First Manufacturing Method)

In the first manufacturing method, first, a cathode 33 and an anode 34 are manufactured as follows.

A cathode material, a binder and a conductive agent are mixed to prepare a cathode mix and the cathode mix is dispersed in a solvent such as N-methyl-2-pyrrolidone to prepare a mixed solution. Then, the cathode mix slurry is applied to a cathode current collector 33A, dried and molded by compression using a roll press machine or the like, to form a cathode active material layer 33B and thereby obtain a cathode 33.

An anode material and a binder are mixed to prepare an anode mix and the anode mix is dispersed in a solvent such as N-methyl-2-pyrrolidone to prepare an anode mix slurry. Then, the anode mix slurry is applied to an anode current collector 34A, dried and molded by compression using a roll press machine or the like, to form an anode active material layer 34B and thereby obtain an anode 34.

Then, a precursor solution containing a non-aqueous solvent, an electrolyte salt, an orthocarbonate ester compound represented by Formula (1), cyclic carbonate ester compounds represented by Formulae (2) to (5), and a solvent is prepared. Then, the precursor solution is applied to the surface of the cathode 33 and the anode 34 and the solvent is volatilized to form a gel electrolyte 36. Subsequently, a cathode lead 31 and an anode lead 32 are mounted on the cathode current collector 33A and anode current collector 34A, respectively. The cathode lead 31 and anode lead 32 may be mounted on the cathode current collector 33 and the anode current collector 34, prior to formation of the electrolyte 36.

Subsequently, the cathode 33 and the anode 34 provided with the electrolyte 36 are laminated through the separator 35, wound in a longitudinal direction, and a protective tape 37 is adhered to the outermost edge thereof to form a wound electrode body 30. Finally, for example, the wound electrode body 30 is inserted between two films of package members 40, the outer edges of the package members 40 are adhered to each other through thermal fusion and the wound electrode body 30 is then sealed under reduced pressure. At this time, an adhesive film 41 is inserted between the cathode lead 31/the anode lead 32 and the package member 40. As a result, the non-aqueous electrolyte battery is completed.

### (Second Manufacturing Method)

In the second manufacturing method, first, a cathode lead 31 and an anode lead 32 are mounted on a cathode current collector 33A and an anode current collector 34A, respectively. In addition, a cathode 33 and an anode 34 are laminated through a separator 35, wound in a longitudinal direction, and a protective tape 37 is adhered onto the outermost edge to form a wound electrode body 30. Subsequently, the wound electrode body 30 is inserted between two films of package members 40, and the remaining outer edges other than the outer edge of one side are adhered through thermal fusion to incorporate the wound electrode body 30 in the pouch package member 40.

Subsequently, a composition for electrolytes which contains an electrolyte containing a non-aqueous solvent, an electrolyte salt, an orthocarbonate ester compound represented by Formula (1), and cyclic carbonate ester compounds represented by Formulae (2) to (5); a monomer as a material for the polymer compound to store and hold the electrolytic solution; and a polymerization initiator; and contains optionally other material such as a polymerization inhibitor is prepared and then incorporated in the pouch package member 40. Finally, an opening of the package member 40 is sealed through thermal fusion or the like, the monomer is thermally polymerized to obtain a polymer compound and thereby form a gel electrolyte 36. As a result, a non-aqueous electrolyte battery is completed.

### (Third Manufacturing Method)

In the third manufacturing method, first, a polymer compound to hold the electrolytic solution is applied to both surfaces of the separator 35. Examples of a polymer compound applied to the separator 35 include polymers (that is, homopolymers, copolymers or multicomponent copolymers) including vinylidene fluoride. Specifically, examples of copolymers include 2-component copolymers including polyvinylidene fluoride or vinylidene fluoride and hexafluoropropylene, and 3-component copolymers including vinylidene fluoride, hexafluoropropylene and chlorotrifluoroethylene. In addition, the polymer compound may contain, in addition to the polymer including the vinylidene fluoride, one or two of other polymer compounds.

Then, a cathode lead 31 and an anode lead 32 are mounted on the cathode current collector 33A and anode current collector 34A, respectively. In addition, the cathode 33 and the anode 34 are laminated through the separator 35, wound in a longitudinal direction, a protective tape 37 is adhered to the outermost edge thereof to form a wound electrode body 30 and the wound electrode body 30 is incorporated in the pouch package member 40. Then, an electrolytic solution containing a non-aqueous solvent, an electrolyte salt, an orthocarbonate ester compound represented by Formula (1) and cyclic carbonate ester compounds represented by Formulae (2) to (5) is injected into the package member 40, and an opening of the package member 40 is sealed through thermal fusion. Finally, the package member 40 is heated with a weight applied thereto, and the separator 35 is adhered to the cathode 33 and the anode 34 through the polymer compound. As a result, the electrolytic solution is impregnated in the polymer compound to form a gel electrolyte 36. As a result, a non-aqueous electrolyte battery is completed.

In the third manufacturing method, as compared to the first manufacturing method, swelling of the non-aqueous electrolyte battery is efficiently suppressed. In addition, in the third manufacturing method, as compared to the second manufacturing method, since the monomer, the material for the polymer compound, the solvent or the like barely remains on the electrolyte 36 and the formation process of the polymer compound is efficiently controlled, sufficient adhesivity between the cathode 33, the anode 34 and the separator 35 and electrolyte 36 can be obtained. For this reason, use of the third manufacturing method is more preferred.

### 3. Third Embodiment

The non-aqueous electrolyte battery according to the third embodiment of the present disclosure will be described. The non-aqueous electrolyte battery according to the third embodiment of the present disclosure is the same as the non-aqueous electrolyte battery according to the second embodiment except that the electrolytic solution in itself is used, instead of the electrolyte held by the polymer compound (electrolyte 36). Accordingly, hereinafter, the configuration of the non-aqueous electrolyte battery will be described in detail, based on the difference between the third embodiment and the second embodiment.

### (Configuration of Non-Aqueous Electrolyte Battery)

The non-aqueous electrolyte battery according to the third embodiment of the present disclosure utilizes an electrolytic solution, instead of the gel electrolyte 36. Accordingly, the wound electrode body 30 includes the electrolytic solution impregnated in the separator 35, instead of the electrolyte 36.

### (Manufacturing Method of Non-Aqueous Electrolyte Battery)

The non-aqueous electrolyte battery is for example manufactured as follows.

First, for example, a cathode active material, a binder and a conductive agent are mixed to prepare a cathode mix and dispersed in a solvent such as N-methyl-2-pyrrolidone to prepare a cathode mix slurry. Then, the cathode mix slurry is applied to both surfaces of a cathode current collector, dried and molded by compression to form a cathode active material layer 33B and thereby manufacture a cathode 33. Then, for example, a cathode lead 31 is adhered to the cathode current collector 33A by ultrasonic welding or spot welding or the like.

First, for example, an anode material and a binder are mixed to prepare an anode mix and dispersed in a solvent such as N-methyl-2-pyrrolidone to prepare an anode mix slurry. Then, the anode mix slurry is applied to both surfaces of an anode current collector 34A, dried and molded by compression to form an anode active material layer 34B and thereby manufacture an anode 34. Then, for example, an anode lead 32 is adhered to the anode current collector 34A by ultrasonic welding or spot welding or the like.

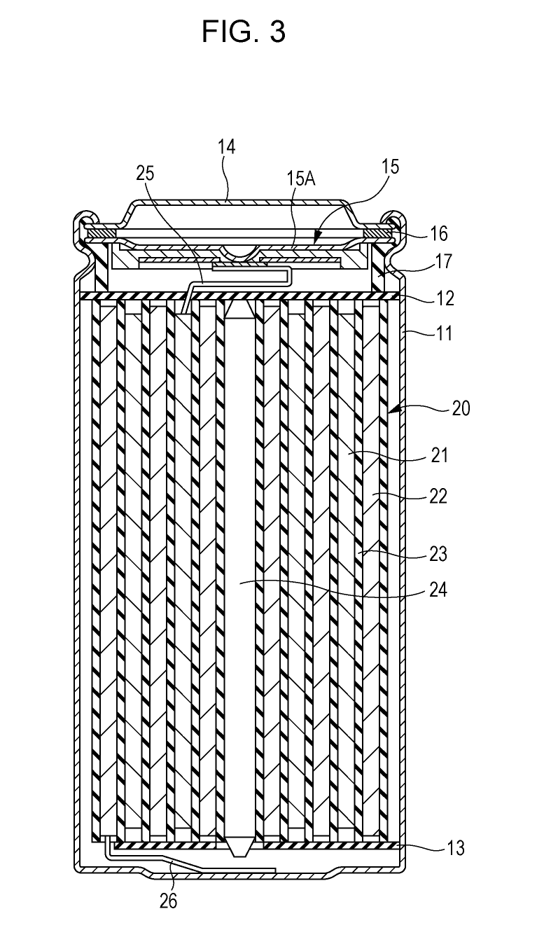

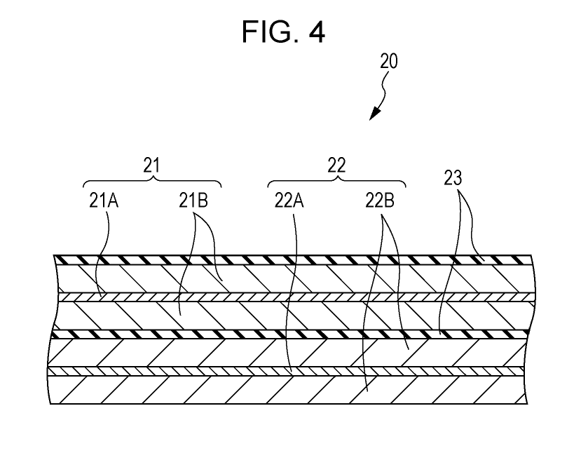

Subsequently, the cathode 33 and the anode 34 are wound through the separator 35, followed by inserting into the package member 40, and the electrolytic solution is injected into the package member 40 and the package member 40 is sealed. As a result, the non-aqueous electrolyte battery shown in FIGS. 3 and 4 is obtained.

### 4. Fourth embodiment

### Configuration of Non-Aqueous Electrolyte Battery

Now, the configuration of the non-aqueous electrolyte battery according to the fourth embodiment of the present disclosure will be described with reference to FIGS. 3 and 4. FIG. 3 illustrates an example of a configuration of the non-aqueous electrolyte battery according to the fourth embodiment of the present disclosure. The non-aqueous electrolyte battery is called a cylindrical battery and includes a wound electrode body 20 in which a band-shaped cathode 21 and a band-shaped anode 22 wound through a separator 23 are present in a hollow cylinder-shaped battery can 11. An electrolytic solution as a liquid electrolyte is impregnated in the separator 23. The battery can 11 is for example composed of nickel (Ni)-plated iron (Fe), and one end thereof closes and the other end thereof opens. A pair of insulating plates 12 and 13 is arranged perpendicularly to the adjacent wound surface in the battery can 11 such that the wound electrode body 20 is interposed between the insulating plates 12 and 13.

A battery cover 14, and a safety valve mechanism 15 and a positive temperature coefficient (PTC) device 16 which are provided inside of the battery cover 14, are caulked with a gasket 17 and thus attached to the open end of the battery can 11. The inside of the battery can 11 is hermetically sealed. The battery cover 14 is made of for example the same material as the battery can 11. The safety valve mechanism 15 is electrically connected to the battery cover 14 through the PTC device 16. In the safety valve mechanism 15, in the case where the internal pressure of the battery becomes a predetermined level or higher due to internal short circuit, external heating or the like, a disk plate 15A flips to cut the electric connection between the battery cover 14 and the wound electrode body 20. As the temperature rises, the PTC device 16 increases the resistance (limits a current) to prevent abnormal heat generation resulting from a large current. The gasket 17 is made of for example an insulating material. The surface of the gasket 17 may be coated with, for example, asphalt.

The wound electrode body 20 is wound based on a center pin 24. A cathode lead 25 made of aluminum (Al) or the like is connected to the cathode 21 of the wound electrode body 20, and an anode lead 26 made of nickel (Ni) or the like is connected to the anode 22. The cathode lead 25 is welded to the safety valve mechanism 15 and thus electrically connected to the battery cover 14. The anode lead 26 is for example welded and thus electrically connected to the battery can 11.

FIG. 4 is an enlarged cross-sectional view illustrating a part of the wound electrode body 20 shown in FIG. 3. The wound electrode body 20 has a structure in which a cathode 21 and an anode 22 are laminated through a separator 23 and wound.

The cathode 21 includes for example a cathode current collector 21A and a cathode active material layer 21B formed on both surfaces of the cathode current collector 21A. The anode 22 includes for example an anode current collector 22A and an anode active material layer 22B formed on both surfaces of the anode current collector 22A. The configurations of the cathode current collector 21A, the cathode active material layer 21B, the anode current collector 22A, the anode active material layer 22B, the separator 23 and the electrolyte are the same as those of the cathode current collector 33A, the cathode active material layer 33B, the anode current collector 34A, the anode active material layer 34B, the separator 35 and the electrolyte in the aforementioned second embodiment.

### (Manufacturing Method of Non-Aqueous Electrolyte Battery)

The aforementioned non-aqueous electrolyte battery may be manufactured in accordance with the following method.

The cathode 21 is produced in the same manner as the cathode 33 in the second embodiment. The anode 22 is produced in the same manner as the anode 34 in the second embodiment.

Then, the cathode lead 25 is attached to the cathode current collector 21A by welding or the like and the anode lead 26 is attached to the anode current collector 22A by welding or the like. Then, the cathode 21 and the anode 22 are wound through the separator 23, the apical end of the cathode lead 25 is welded to the safety valve mechanism 15, the apical end of the anode lead 26 is welded to the battery can 11, the wound cathode 21 and the anode 22 are inserted between a pair of insulating plates 12 and 13, and the cathode 21 and the anode 22 are incorporated into the battery can 11. After the cathode 21 and the anode 22 are incorporated into the battery can 11, the electrolytic solution is injected into the battery can 11 and then impregnated in the separator 23. Then, at the passage end of the battery can 11, the battery cover 14, the safety valve mechanism 15 and the PTC device 16 are caulked and fixed through the gasket 17. As a result, the non-aqueous secondary battery illustrated in FIG. 3 is completed.

### EXAMPLE

Specific examples of the present disclosure will be described in detail, but the present disclosure is not limited thereto. In addition, for better understanding, the following compounds used in Examples are represented by Chems. A to M.

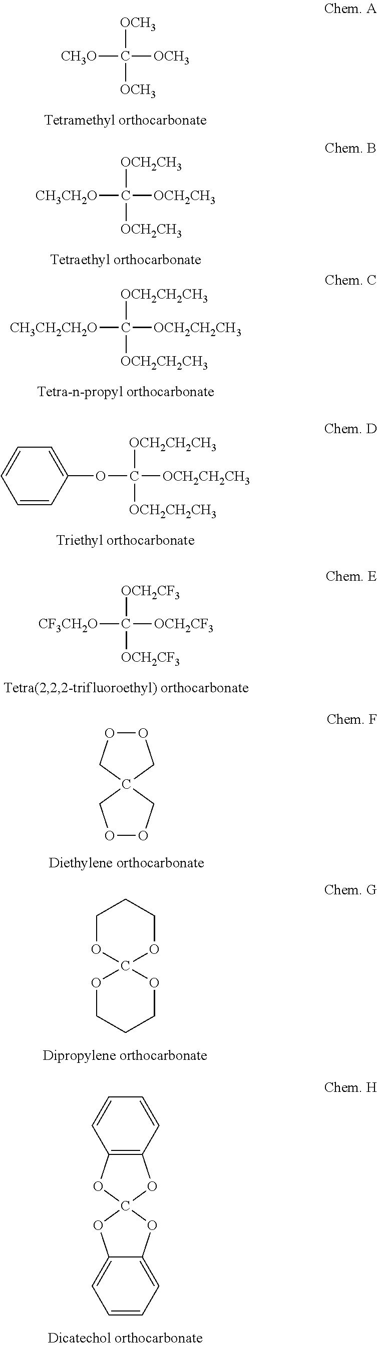

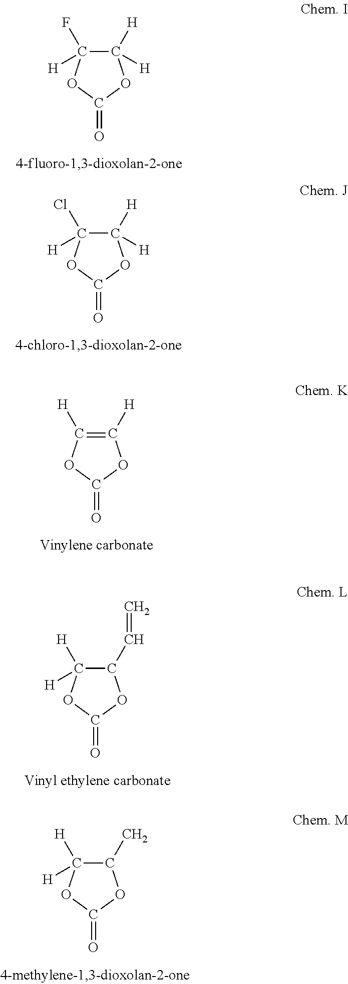

### Example 1-1

A laminate-type secondary battery shown in FIGS. 1 and 2 was manufactured in the following procedure, as an anode active material, using a mixed carbon material of amorphous coated natural graphite and natural graphite (MAGX-SO2, manufactured by Hitachi Chemical Co., Ltd.).

First, 94 parts by mass of lithium cobaltate (LiCoO₂) as a cathode active material, 3 parts by mass of graphite as a conductive agent and 3 parts by mass of polyvinylidene fluoride (PVdF) as a binder were homogeneously mixed, and N-methylpyrrolidone was added thereto to obtain a cathode mix slurry.

Then, the cathode mix slurry was uniformly applied to both surfaces of an aluminum (Al) foil with a thickness of 10 μm, followed by drying and molding by compression to form a cathode active material layer with a thickness of 30 μm per surface (volumetric density of cathode active material layer: 3.40 g/cc). The cathode active material layer was cut into a shape with a width of 50 mm and a length of 300 mm to obtain a cathode.

In addition, 97 parts by mass of a mixed graphite material of amorphous coated natural graphite and natural graphite (MAGX-SO2, manufactured by Hitachi Chemical Co., Ltd.) as an anode active material, 1 part by weight of carboxymethyl cellulose as a binder and 2 parts by mass of a styrene butadiene rubber were homogeneously mixed to prepare an anode mixture. At that time, the anode active material had a specific surface area (BET specific surface area) of 3.61 m²/g.

Then, the anode mix slurry was uniformly applied to both surfaces of a copper (Cu) foil with a thickness of 10 μm, serving as an anode current collector, followed by drying and pressing at 200 MPa to form an anode active material layer with a thickness of 34 μm per surface. The anode active material layer was cut into a shape with a width of 50 mm and a length of 300 mm to obtain an anode (volumetric density of anode active material layer: 1.60 g/cc, specific surface area of anode active material: 3.61 m²/g).

Polyvinylidene fluoride which is a polymer material for holding an electrolytic solution thereon was coated to a thickness of 2 μm on both surfaces of a microporous polyethylene film having a thickness of 7 μm, to manufacture a separator.

An electrolytic solution was prepared as follows. First, a solution of 1.0 mol/kg of lithium hexafluorophosphate (LiPF₆) as an electrolyte salt dissolved in a mixed solvent of ethylene carbonate (EC):diethyl carbonate (DEC) (EC:DEC=4:6 (weight ratio)) was prepared. Chem. A as an orthocarbonate ester compound represented by Formula (1) was added to the solution such that the concentration thereof was adjusted to 0.005% by mass, based on the total weight of the electrolytic solution, and Chem. I as a cyclic carbonate ester compound was added thereto such that the concentration thereof was adjusted to 1% by mass, based on the total amount of the electrolytic solution.

Then, the cathode and the anode were wound through the separator, the resulting structure was housed in a pouch package member made of an aluminum laminate film, and 2 g of the electrolytic solution was injected into the package member. Then, an envelope was thermally fused. As a result, the laminate-type battery of Example 1-1 was manufactured.

### Example 1-2

A laminate-type battery was manufactured in the same manner as in Example 1-1, except that the concentration of Chem. A was changed to 0.01% by mass in the process of preparing the electrolytic solution.

### Example 1-3

A laminate-type battery was manufactured in the same manner as in Example 1-1, except that the concentration of Chem. A was changed to 0.5% by mass and the concentration of Chem. I was changed to 0.5% by mass in the process of preparing the electrolytic solution.

### Example 1-4

A laminate-type battery was manufactured in the same manner as in Example 1-1, except that the concentration of Chem. A was changed to 0.5% by mass in the process of preparing the electrolytic solution.

### Example 1-5

A laminate-type battery was manufactured in the same manner as in Example 1-1, except that the concentration of Chem. A was changed to 0.5% by mass and the concentration of Chem. I was changed to 3% by mass in the process of preparing the electrolytic solution.

### Example 1-6

A laminate-type battery was manufactured in the same manner as in Example 1-1, except that the concentration of Chem. A was changed to 0.5% by mass and the concentration of Chem. I was changed to 5% by mass in the process of preparing the electrolytic solution.

### Example 1-7

A laminate-type battery was manufactured in the same manner as in Example 1-1, except that the concentration of Chem. A was changed to 1% by mass in the process of preparing the electrolytic solution.

### Example 1-8

A laminate-type battery was manufactured in the same manner as in Example 1-1, except that the concentration of Chem. A was changed to 2% by mass in the process of preparing the electrolytic solution.

### Example 1-9

A laminate-type battery was manufactured in the same manner as in Example 1-1, except that the concentration of Chem. A was changed to 0.01% by mass and the concentration of Chem. K was changed to 1% by mass instead of Chem. I in the process of preparing the electrolytic solution.

### Example 1-10

A laminate-type battery was manufactured in the same manner as in Example 1-1, except that the concentration of Chem. A was changed to 0.5% by mass, and 0.5% by mass of Chem. K was added instead of Chem. I in the process of preparing the electrolytic solution.

### Example 1-11

A laminate-type battery was manufactured in the same manner as in Example 1-1, except that the concentration of Chem. A was changed to 0.5% by mass, and 1% by mass of Chem. K was added instead of Chem. I in the process of preparing the electrolytic solution.

### Example 1-12

A laminate-type battery was manufactured in the same manner as in Example 1-1, except that the concentration of Chem. A was changed to 0.5% by mass, and 3% by mass of Chem. K was added instead of Chem. I in the process of preparing the electrolytic solution.

### Example 1-13

A laminate-type battery was manufactured in the same manner as in Example 1-1, except that the concentration of Chem. A was changed to 1% by mass, and 1% by mass of Chem. K was added instead of Chem. I in the process of preparing the electrolytic solution.

### Example 1-14

A laminate-type battery was manufactured in the same manner as in Example 1-1, except that 0.01% by mass of Chem. F was added instead of Chem. A in the process of preparing the electrolytic solution.

### Example 1-15

A laminate-type battery was manufactured in the same manner as in Example 1-1, except that 0.5% by mass of Chem. F was added instead of Chem. A and the concentration of Chem. I was changed to 0.5% by mass in the process of preparing the electrolytic solution.

### Example 1-16

A laminate-type battery was manufactured in the same manner as in Example 1-1, except that 0.5% by mass of Chem. F was added instead of Chem. A in the process of preparing the electrolytic solution.

### Example 1-17

A laminate-type battery was manufactured in the same manner as in Example 1-1, except that 0.5% by mass of Chem. F was added instead of Chem. A and the concentration of Chem. I was changed to 3% by mass in the process of preparing the electrolytic solution.

### Example 1-18

A laminate-type battery was manufactured in the same manner as in Example 1-1, except that 1% by mass of Chem. F was added instead of Chem. A in the process of preparing the electrolytic solution.

### Example 1-19

A laminate-type battery was manufactured in the same manner as in Example 1-1, except that 2% by mass of Chem. F was added instead of Chem. A in the process of preparing the electrolytic solution.

### Example 1-20

A laminate-type battery was manufactured in the same manner as in Example 1-1, except that 0.01% by mass of Chem. G was added instead of Chem. A in the process of preparing the electrolytic solution.

### Example 1-21

A laminate-type battery was manufactured in the same manner as in Example 1-1, except that 0.5% by mass of Chem. G was added instead of Chem. A and the concentration of Chem. I was changed to 0.5% by mass in the process of preparing the electrolytic solution.

### Example 1-22

A laminate-type battery was manufactured in the same manner as in Example 1-1, except that 0.5% by mass of Chem. G was added instead of Chem. A in the process of preparing the electrolytic solution.

### Example 1-23

A laminate-type battery was manufactured in the same manner as in Example 1-1, except that 0.5% by mass of Chem. G was added instead of Chem. A and the concentration of Chem. I was changed to 3% by mass in the process of preparing the electrolytic solution.

### Example 1-24

A laminate-type battery was manufactured in the same manner as in Example 1-1, except that 1% by mass of Chem. G was added instead of Chem. A in the process of preparing the electrolytic solution.

### Example 1-25

A laminate-type battery was manufactured in the same manner as in Example 1-1, except that 2% by mass of Chem. G was added instead of Chem. A in the process of preparing the electrolytic solution.

### Comparative Example 1-1

A laminate-type battery was manufactured in the same manner as in Example 1-1, except that Chem. A and Chem. I were not added in the process of preparing the electrolytic solution.

### Comparative Example 1-2

A laminate-type battery was manufactured in the same manner as in Example 1-1, except that the concentration of Chem. A was changed to 1% by mass and Chem. I was not added in the process of preparing the electrolytic solution.

### Comparative Example 1-3

A laminate-type battery was manufactured in the same manner as in Example 1-1, except that Chem. A was not added in the process of preparing the electrolytic solution.

The laminate-type batteries of Examples 1-1 to 1-25 and Comparative Examples 1-1 to 1-3 were evaluated as follows.

### (Evaluation)

For the respective laminated-type batteries of Examples and Comparative Examples, gas generation during initial charge, discharge capacity retention rate after long-term cycling, increase in cell thickness after long-term cycling, load characteristics, and variation in resistance after storage at a high temperature (60° C.) were measured as follows.

### (Measurement of Gas Generation During Initial Charge)

The batteries were subjected to constant-current charge at a constant current of 900 mA to an upper limit voltage of 4.2 V under an environment at 23° C. Then, the presence or absence of deformation of the battery cell caused by gas generation during the initial charge was confirmed. With respect to the cell in which the gas generation was observed, an increase rate of the thickness of the cell was determined. Then, the batteries were subjected to constant-current discharge at 900 mA to a cut-off voltage of 3.0 V and an initial discharge capacity was then measured.

### (Initial Capacity and Long-Term Cycle Test)

First, each battery was subjected to charge/discharge in one cycle at 900 mA under an environment of 23° C. and an initial discharge capacity was then determined. Subsequently, the charge and discharge cycle was repeated 300 times under an environment of 23° C. At this time, a discharge capacity retention rate was calculated in accordance with the following equation: discharge capacity retention rate (%)=(Discharge capacity at 300th cycle/Discharge capacity at first cycle)×100. The charge/discharge cycle included constant-current constant-voltage charge in a current of 1C to an upper limit voltage of 4.2 V and constant-current discharge in a current of 1C to a cut-off voltage of 3.0 V. The term “1C” refers to a current value at which a theoretical capacity is completely discharged for one hour.

(Measurement of Increase in Cell Thickness after Long-Term Cycling)

With respect to batteries which underwent 300 cycles of charge and discharge in the long-term cycle test, the difference between battery thickness after 300 cycles and battery thickness after initial discharge was obtained as an increase in cell thickness after long-term cycling.

(Evaluation of Load Characteristic after Long-Term Use)

The batteries which underwent 300 cycles of charge and discharge was subjected to constant-current and constant-voltage charge to an upper limit voltage of 4.2 V in a current of 1C and then subjected to constant-current discharge to a cut-off voltage of 3.0 V in a current of 0.2C. At this time, a discharge capacity (0.2C discharge capacity) was measured. Next, the battery was subjected to constant-current and constant-voltage charge to an upper limit voltage of 4.2 V in a current of 1C and then subjected to constant-current discharge to a cut-off voltage of 3.0 V in a current of 3C. At this time, a discharge capacity (3C discharge capacity) was measured and the load characteristics are obtained by calculation of (3C discharge capacity/0.2C discharge capacity)×100(%). The term “0.2C” used herein refers to a current value at which a theoretical capacity is completely discharged for 5 hours; and the term “3C” used herein refers to a current value at which a theoretical capacity is completely discharged for 20 minutes.

(Measurement of Resistance after Storage at High Temperature)

The laminated-type battery was subjected to constant-current charge in a constant current of 900 mA under an environment at 23° C. to an upper limit voltage of 4.2 V and then subjected to constant-voltage charge. Then, scanning was conducted at a frequency of from 1 mHz to 50 mHz using an AC impedance measurement apparatus, and a Cole-Cole plot in which the ordinate expresses an imaginary part and the abscissa expresses a real part was prepared. Subsequently, an arc portion of this Cole-Cole plot was subjected to fitting with a circle, and a larger value of two points intersecting with the real part of this circle was defined as a resistance of the battery. The charged battery was stored in a thermostat-controlled oven at 60° C. for 15 days. Then, resistance of the battery was measured in the same manner as described above. Then, variation in resistance after storage at 60° C. was calculated in accordance with the equation of [mΩ]=(Resistance after storage at 60° C.)−(Resistance at the initial charge).

The evaluation results of Examples 1-1 to 1-25 and Comparative Examples 1-1 to 1-3 are shown in Table 1.

TABLE 1

| | | | | | Gas | Discharge | | | |
|---|---|---|---|---|---|---|---|---|---|
| | | | | | generation | capacity | Increase in | | Variation in |
| | Orthocarbonate ester | | Cyclic carbonate ester | | during | retention | cell | Load | resistance after |
| | compound | | compound | | initial | rate | thickness | characteristics | storage at |
| | Type | mass (%) | Type | Mass (%) | charge (*1) | (%) | (mm) | (%) | 60° C. (mΩ) |
| Ex. 1-1 | Chem. A | 0.005 | Chem. I | 1 | − | 75 | 0.40 | 60 | 26 |
| Ex. 1-2 | | 0.01 | | 1 | − | 83 | 0.39 | 69 | 21 |
| Ex. 1-3 | | 0.5 | | 0.5 | − | 91 | 0.37 | 80 | 14 |
| Ex. 1-4 | | | | 1 | − | 92 | 0.35 | 81 | 14 |
| Ex. 1-5 | | | | 3 | − | 92 | 0.36 | 81 | 15 |
| Ex. 1-6 | | | | 5 | − | 91 | 0.36 | 80 | 20 |
| Ex. 1-7 | | 1 | | 1 | + | 90 | 0.36 | 80 | 15 |
| Ex. 1-8 | | 2 | | 1 | ++ | 88 | 0.41 | 78 | 17 |
| Ex. 1-9 | Chem. A | 0.01 | Chem. K | 1 | − | 81 | 0.42 | 68 | 23 |
| Ex. 1-10 | | 0.5 | | 0.5 | − | 90 | 0.40 | 81 | 15 |
| Ex. 1-11 | | | | 1 | − | 90 | 0.40 | 80 | 15 |
| Ex. 1-12 | | | | 3 | − | 92 | 0.38 | 78 | 18 |
| Ex. 1-13 | | 1 | | 1 | ++ | 91 | 0.37 | 80 | 16 |
| Ex. 1-14 | Chem. F | 0.01 | Chem. I | 1 | − | 82 | 0.40 | 67 | 22 |
| Ex. 1-15 | | 0.5 | | 0.5 | − | 90 | 0.36 | 81 | 16 |
| Ex. 1-16 | | | | 1 | − | 91 | 0.36 | 81 | 16 |
| Ex. 1-17 | | | | 3 | − | 90 | 0.35 | 82 | 15 |
| Ex. 1-18 | | 1 | | 1 | + | 90 | 0.36 | 80 | 18 |
| Ex. 1-19 | | 2 | | 1 | + | 89 | 0.36 | 80 | 18 |
| Ex. 1-20 | Chem. G | 0.01 | Chem. I | 1 | − | 84 | 0.35 | 70 | 18 |
| Ex. 1-21 | | 0.5 | | 0.5 | − | 92 | 0.33 | 81 | 14 |
| Ex. 1-22 | | | | 1 | − | 92 | 0.31 | 83 | 15 |
| Ex. 1-23 | | | | 3 | − | 93 | 0.31 | 83 | 15 |
| Ex. 1-24 | | 1 | | 1 | − | 93 | 0.32 | 82 | 14 |
| Ex. 1-25 | | 2 | | 1 | − | 91 | 0.34 | 82 | 14 |
| Comp. Ex. 1-1 | — | — | — | — | + | 62 | 0.85 | 52 | 40 |
| Comp. Ex. 1-2 | Chem. A | 1 | — | — | +++ | 68 | 1.37 | 56 | 42 |
| Comp. Ex. 1-3 | — | — | Chem. I | 1 | − | 72 | 0.40 | 53 | 39 |

The following can be seen from Table 1. By using a non-aqueous electrolyte containing an orthocarbonate ester compound represented by Formula (1) such as Chem. A and a cyclic carbonate ester compound represented by Formula (2) such as Chem. I, gas generation during the initial charge could be suppressed and the increase in cell thickness after long-term cycling could be inhibited. As compared to Comparative Example 1-1, Examples 1-1 to 1-25 exhibited inhibition of capacity deterioration (deterioration of discharge capacity retention rate), increase in cell thickness after cycles, deterioration of load characteristics after cycles and increase in resistance after storage which were involved in cycles. Comparative Example 1-2 could not inhibit gas generation during the initial charge, since it used a non-aqueous electrolyte which contained Chem. A, but did not contain Chem. I. As compared to Examples 1-1 to 1-25, Comparative Example 1-3 could not inhibit deterioration of discharge capacity retention rate, deterioration of load characteristics after cycles and increase in resistance after storage, since it used a non-aqueous electrolyte which contained Chem. I, but did not contain Chem. A. In addition, it can be seen in Examples 1-1 to 1-8 that it is preferable that the content of compound represented by Formula (1) is 0.01% by mass to 1% by mass, from the viewpoints of gas generation during the initial charge and variation in resistance after storage.

It can be seen from Examples 1-1 to 1-8 and Examples 1-14 to 1-25 that the orthocarbonate ester compound represented by Formula (1A) having a spiro ring such as Chem. F and Chem. G had a low possibility of gas generation, as compared to the orthocarbonate ester compound having no ring, such as Chem. A. In addition, it can be seen that Chem. F had a low possibility of gas generation, as compared to Chem. G.

### Example 2-1

A laminate-type battery was manufactured in the same manner as in Example 1-4.

### Examples 2-2 to 2-5

Respective laminate-type batteries were manufactured in the same manner as in Example 2-1 except that Chem. J, Chem. K, Chem. L or Chem. M was added, instead of Chem. I.

### Examples 2-6 to 2-10

Respective laminate-type batteries were manufactured in the same manner as in Examples 2-1 to 2-5 except that Chem. B was added, instead of Chem. A.

### Examples 2-11 to 2-15

Respective laminate-type batteries were manufactured in the same manner as in Examples 2-1 to 2-5 except that Chem. C was added, instead of Chem. A.

### Examples 2-16 to 2-20

Respective laminate-type batteries were manufactured in the same manner as in Examples 2-1 to 2-5 except that Chem. D was added, instead of Chem. A.

### Examples 2-21 to 2-25

Respective laminate-type batteries were manufactured in the same manner as in Examples 2-1 to 2-5 except that Chem. E was added, instead of Chem. A.

### Examples 2-26 to 2-30

Respective laminate-type batteries were manufactured in the same manner as in Examples 2-1 to 2-5 except that Chem. F was added, instead of Chem. A.

### Examples 2-31 to 2-35

Respective laminate-type batteries were manufactured in the same manner as in Examples 2-1 to 2-5 except that Chem. G was added, instead of Chem. A.

### Examples 2-36 to 2-40

Respective laminate-type batteries were manufactured in the same manner as in Examples 2-1 to 2-5 except that Chem. H was added, instead of Chem. A.

### (Evaluation)

With respect to the laminate-type batteries of Examples 2-1 to 2-40, in the same manner as Example 1-1, gas generation during initial charge, increase in cell thickness after long-term cycling, load characteristics, and variation in resistance after storage at a high temperature were evaluated. The evaluation results are shown in Table 2.

TABLE 2

| | | | | | Gas | Discharge | Increase | | |
|---|---|---|---|---|---|---|---|---|---|
| | Orthocarbonate ester | | Cyclic carbonate ester | | generation | capacity | in cell | Load | Variation in |
| | compound | | compound | | during initial | retention rate | thickness | characteristics | resistance after |
| | Type | Mass (%) | Type | Mass (%) | charge (*1) | (%) | (mm) | (%) | storage at 60° C. |
| Ex. 2-1 | Chem. A | 0.5 | Chem. I | 1 | − | 92 | 0.35 | 81 | 14 |
| Ex. 2-2 | | | Chem. J | | − | 82 | 0.42 | 74 | 20 |
| Ex. 2-3 | | | Chem. K | | − | 90 | 0.40 | 80 | 15 |
| Ex. 2-4 | | | Chem. L | | − | 89 | 0.39 | 78 | 16 |
| Ex. 2-5 | | | Chem. M | | − | 86 | 0.40 | 77 | 17 |
| Ex. 2-6 | Chem. B | 0.5 | Chem. I | 1 | − | 92 | 0.31 | 84 | 14 |
| Ex. 2-7 | | | Chem. J | | − | 86 | 0.40 | 76 | 19 |
| Ex. 2-8 | | | Chem. K | | − | 92 | 0.34 | 82 | 15 |
| Ex. 2-9 | | | Chem. L | | − | 91 | 0.36 | 81 | 16 |
| Ex. 2-10 | | | Chem. M | | − | 88 | 0.36 | 79 | 18 |
| Ex. 2-11 | Chem. C | 0.5 | Chem. I | 1 | − | 91 | 0.32 | 82 | 14 |
| Ex. 2-12 | | | Chem. J | | − | 83 | 0.41 | 72 | 18 |
| Ex. 2-13 | | | Chem. K | | − | 90 | 0.36 | 80 | 15 |
| Ex. 2-14 | | | Chem. L | | − | 89 | 0.36 | 79 | 16 |
| Ex. 2-15 | | | Chem. M | | − | 88 | 0.40 | 78 | 18 |
| Ex. 2-16 | Chem. D | 0.5 | Chem. I | 1 | − | 90 | 0.33 | 82 | 15 |
| Ex. 2-17 | | | Chem. J | | − | 83 | 0.42 | 70 | 20 |
| Ex. 2-18 | | | Chem. K | | − | 90 | 0.35 | 80 | 15 |
| Ex. 2-19 | | | Chem. L | | − | 88 | 0.36 | 77 | 16 |
| Ex. 2-20 | | | Chem. M | | − | 88 | 0.41 | 77 | 19 |
| Ex. 2-21 | Chem. E | 0.5 | Chem. I | 1 | − | 91 | 0.33 | 84 | 15 |
| Ex. 2-22 | | | Chem. J | | − | 87 | 0.42 | 78 | 20 |
| Ex. 2-23 | | | Chem. K | | − | 92 | 0.34 | 83 | 15 |
| Ex. 2-24 | | | Chem. L | | − | 90 | 0.38 | 82 | 17 |
| Ex. 2-25 | | | Chem. M | | − | 89 | 0.37 | 80 | 19 |
| Ex. 2-26 | Chem. F | 0.5 | Chem. I | 1 | − | 91 | 0.36 | 81 | 16 |
| Ex. 2-27 | | | Chem. J | | − | 83 | 0.40 | 74 | 19 |
| Ex. 2-28 | | | Chem. K | | − | 91 | 0.38 | 80 | 16 |
| Ex. 2-29 | | | Chem. L | | − | 88 | 0.40 | 79 | 16 |
| Ex. 2-30 | | | Chem. M | | − | 85 | 0.41 | 78 | 18 |
| Ex. 2-31 | Chem. G | 0.5 | Chem. I | 1 | − | 92 | 0.31 | 83 | 15 |
| Ex. 2-32 | | | Chem. J | | − | 85 | 0.38 | 76 | 20 |
| Ex. 2-33 | | | Chem. K | | − | 91 | 0.35 | 81 | 16 |
| Ex. 2-34 | | | Chem. L | | − | 91 | 0.35 | 81 | 16 |
| Ex. 2-35 | | | Chem. M | | − | 88 | 0.36 | 78 | 18 |
| Ex. 2-36 | Chem. H | 0.5 | Chem. I | 1 | − | 89 | 0.31 | 80 | 16 |
| Ex. 2-37 | | | Chem. J | | − | 82 | 0.40 | 69 | 21 |
| Ex. 2-38 | | | Chem. K | | − | 90 | 0.35 | 78 | 17 |
| Ex. 2-39 | | | Chem. L | | − | 88 | 0.35 | 77 | 18 |
| Ex. 2-40 | | | Chem. M | | − | 87 | 0.40 | 76 | 19 |

(*1) −: no gas generation, +: increase in cell thickness <10%, ++: 10% ≦ increase in cell thickness

The following can be seen from Table 2. In cases where the orthocarbonate ester compound having an aryl group, such as Chem. D, the orthocarbonate ester compound having a halogen group such as Chem. E, and the orthocarbonate ester compound having a spiro ring such as Chem. F, Chem. G and Chem. H were used as the orthocarbonate ester compound represented by Formula (1), the following can be seen. That is, deterioration of discharge capacity retention rate, increase in cell thickness after cycles, deterioration of load characteristics after cycles and increase in resistance after storage which were involved in cycles could be inhibited. In addition, it can be seen that although the cyclic carbonate ester compound having chlorine represented by Formula (2), such as Chem. J, the cyclic carbonate ester compound having an unsaturated bond, represented by Formula (3), such as Chem. K, the cyclic carbonate ester compound having an unsaturated bond, represented by Formula (4), such as Chem. L, or the cyclic carbonate ester compound having an unsaturated bond, represented by Formula (5) such as Chem. M, was used, instead of the cyclic carbonate ester compound having fluoride as halogen, the identical effects could be obtained. It can be seen that the cyclic carbonate ester having fluorine such as Chem. I or the cyclic carbonate ester compound represented by Formula (3) such as Chem. K is preferred from viewpoints of capacity retention rate and load characteristics.

### Example 3-1

Only a mixed carbon material of amorphous coated natural graphite and natural graphite (MAGX-SO2, manufactured by Hitachi Chemical Co., Ltd.) was used as an anode active material, dried and then pressed such that an anode mix density became 1.65 g/cc. In addition, the specific surface area of the anode active material was 3.61 m²/g.

An electrolytic solution was prepared as follows. First, a solution of 1.0 mol/kg of lithium hexafluorophosphate (LiPF₆) as an electrolyte salt dissolved in a mixed solvent of ethylene carbonate (EC):diethyl carbonate (DEC) (EC:DEC=4:6 (weight ratio)) was prepared. Chem. A as an orthocarbonate ester compound represented by Formula (1) was added to the solution such that the concentration thereof was adjusted to 0.5% by mass, based on the total weight of the electrolytic solution, and Chem. I as a cyclic carbonate ester compound was added thereto such that the concentration thereof was adjusted to 1% by mass, based on the total amount of the electrolytic solution.

A laminate-type battery was manufactured in the same manner as in Example 1-1 except for the foregoing.

### Example 3-2

A laminate-type battery was manufactured in the same manner as in Example 3-1 except only a mixed carbon material of amorphous coated natural graphite and natural graphite (MAGX-SO2, manufactured by Hitachi Chemical Co., Ltd.) was used as an anode active material, dried and then pressed such that an anode mix density became 1.60 g/cc.

### Example 3-3

A laminate-type battery was manufactured in the same manner as in Example 3-1 except only a mixed carbon material of amorphous coated natural graphite and natural graphite (MAGX-SO2, manufactured by Hitachi Chemical Co., Ltd.) was used as an anode active material, dried and then pressed such that an anode mix density became 1.50 g/cc.

### Example 3-4

A homogeneous mixture of 20 parts by mass of mesocarbon microbead (MCMB) graphite, and 80 parts by mass of a mixed carbon material of amorphous coated natural graphite and natural graphite (MAGX-SO2, manufactured by Hitachi Chemical Co., Ltd.) was used as an anode active material. The specific surface area of the anode active material was 3.05 m²/g. The anode active material was dried and then pressed such that the anode mix density became 1.60 g/cc. A laminate-type battery was manufactured in the same manner as in Example 3-1 except for the foregoing.

### Example 3-5

A homogeneous mixture of 50 parts by mass of mesocarbon microbead (MCMB) graphite, and 50 parts by mass of a mixed carbon material of amorphous coated natural graphite and natural graphite (MAGX-SO2, manufactured by Hitachi Chemical Co., Ltd.) was used as an anode active material. The specific surface area of the anode active material was 2.08 m²/g. The anode active material was dried and then pressed such that the anode mix density became 1.60 g/cc. A laminate-type battery was manufactured in the same manner as in Example 3-1 except for the foregoing.

### Example 3-6

A homogeneous mixture of 80 parts by mass of mesocarbon microbead (MCMB) graphite, and 20 parts by mass of a mixed carbon material of amorphous coated natural graphite and natural graphite (MAGX-SO2, manufactured by Hitachi Chemical Co., Ltd.) was used as an anode active material. The specific surface area of the anode active material was 1.10 m²/g. The anode active material was dried and then pressed such that the anode mix density became 1.60 g/cc. A laminate-type battery was manufactured in the same manner as in Example 3-1 except for the foregoing.

### Example 3-7

Only mesocarbon microbead (MCMB) graphite was used, 97 parts by mass of MCMB-based lead was homogeneously mixed with 3 parts by mass of PVdF as a binder, and N-methylpyrrolidone was added to the mixture to obtain an anode mix slurry. The anode mix slurry was used as an anode active material. The specific surface area of the anode active material was 0.45 m²/g. The anode active material was dried and then pressed such that the anode mix density became 1.60 g/cc. A laminate-type battery was manufactured in the same manner as in Example 3-1 except for the foregoing.

### Comparative Example 3-1

A laminate-type battery was manufactured in the same manner as in Example 3-2 except that Chem. A and Chem. I were not added in the process of preparing the electrolyte.

### Comparative Example 3-2

A laminate-type battery was manufactured in the same manner as in Example 3-2 except that the concentration of the Chem. A was changed to 1% by mass and Chem. I was not added in the process of preparing the electrolyte.

### Comparative Example 3-3

A laminate-type battery was manufactured in the same manner as in Example 3-2 except that Chem. A was not added in the process of preparing the electrolytic solution.

### Comparative Example 3-4

A laminate-type battery was manufactured in the same manner as in Example 3-7 except that Chem. A and Chem. I were not added in the process of preparing the electrolyte.

### Comparative Example 3-5

A laminate-type battery was manufactured in the same manner as in Example 3-7 except that the concentration of Chem. A was changed to 1% by mass and Chem. I was not added in the process of preparing the electrolyte.

### Comparative Example 3-6

A laminate-type battery was manufactured in the same manner as in Example 3-7 except that Chem. A was not added in the process of preparing the electrolyte.

### (Evaluation)

With respect to the laminate-type batteries of Examples 3-1 to 3-7, and Comparative Examples 3-1 to 3-6, gas generation during initial charge, increase in cell thickness after long-term cycling, load characteristics, and variation in resistance after storage at a high temperature were evaluated in the same manner as Example 1-1. The evaluation results are shown in Table 3.

TABLE 3

| | | | Orthocarbonate | | Cyclic | | | | | | |
|---|---|---|---|---|---|---|---|---|---|---|---|
| | | | ester | | carbonate | | Gas | Discharge | Increase in | | Variation in |
| | | | compound | | ester compound | | generation | capacity | cell | Load | resistance |
| | Carbon | Carbon | | Mass | | Mass | during initial | retention rate | thickness | characteristics | after storage |
| | material 1 (*2) | material 2 (*2) | Type | (%) | Type | (%) | charge (*1) | (%) | (mm) | (%) | at 60° C. |
| Ex. 3-1 | — | MAGX- | Chem. A | 0.5 | Chem. I | 1 | − | 92 | 0.35 | 80 | 14 |
| Ex. 3-2 | | SO2 (10) | | | | | − | 92 | 0.35 | 81 | 14 |
| Ex. 3-3 | | | | | | | − | 89 | 0.31 | 83 | 17 |
| Ex. 3-4 | MCMB | MAGX- | | | | | − | 91 | 0.33 | 81 | 16 |
| | (2) | SO2 (8) | | | | | | | | | |
| Ex. 3-5 | MCMB | MAGX- | | | | | − | 90 | 0.34 | 80 | 15 |
| | (5) | SO2 (5) | | | | | | | | | |
| Ex. 3-6 | MCMB | MAGX- | | | | | − | 87 | 0.41 | 79 | 15 |
| | (8) | SO2 (2) | | | | | | | | | |
| Ex. 3-7 | MCMB | — | | | | | − | 79 | 0.48 | 77 | 14 |
| | (10) | | | | | | | | | | |
| Comp. | — | MAGX- | — | — | | — | + | 62 | 0.85 | 52 | 40 |
| Ex. 3-1 | | SO2 (10) | | | | | | | | | |
| Comp. | — | MAGX- | Chem. A | 1 | | — | ++ | 68 | 1.37 | 56 | 42 |
| Ex. 3-2 | | SO2 (10) | | | | | | | | | |
| Comp. | — | MAGX- | — | — | Chem. I | 1 | − | 72 | 0.40 | 53 | 39 |
| Ex. 3-3 | | SO2 (10) | | | | | | | | | |
| Comp. | MCMB | — | — | — | | — | + | 65 | 0.81 | 62 | 32 |
| Ex. 3-4 | (10) | | | | | | | | | | |
| Comp. | MCMB | — | Chem. A | 1 | | — | + | 68 | 1.18 | 64 | 35 |
| Ex. 3-5 | (10) | | | | | | | | | | |
| Comp. | MCMB | — | — | — | Chem. I | 1 | − | 73 | 0.51 | 61 | 33 |
| Ex. 3-6 | (10) | | | | | | | | | | |

(*1) −: no gas generation, +: increase in cell thickness <10%, ++: 10% ≦ increase in cell thickness
(*2): the value in ( ) means mass ratio of carbon material 1 and carbon material 2

As is apparent from Table 3, by using a carbon material with a controlled specific surface area as an anode active material, the effects obtained by incorporating the orthocarbonate ester compound represented by Formula (1) and the cyclic carbonate ester compounds represented by Formulae (2) to (5) can be efficiently obtained. In Examples 3-4 to 3-6, when the specific surface area of the anode active material decreases, electrode reaction area decreases and load characteristics may be thus further deteriorated. Meanwhile, in Example 3-7, when the specific surface area of the anode active material is excessively high, gas generation during initial charge, cycle or storage may increase. In addition, in the case of controlling the specific surface area of the overall active material through mixing of the carbon material, instead of using a carbon material in which a specific surface area thereof is controlled by surface-treatment, the identical effects can be obtained.

### 5. Other Embodiments

### Modified Examples

The present disclosure is not limited to the aforementioned example embodiments and includes a variety of modifications and applications within the subject matters of the present disclosure. For example, although a non-aqueous electrolyte battery having a wound structure has been described in detail in the aforementioned embodiments and Examples, the present disclosure is not limited thereto. For example, the present disclosure may be also applicable to battery devices having a laminated and wound structure including a cathode and an anode, or non-aqueous electrolyte batteries having other laminate structures including a cathode and an anode.

In addition, although a case where a cylindrical can-type package member is used as a film-type package member has been described in aforementioned embodiments and Examples, a square-, coin- or button-type can may be used as the package member.

In addition, although a case where lithium is used for an electrode reaction has been described in aforementioned embodiments and Examples, the present disclosure can exhibit the identical effects when applied to cases of using other alkali metals such as sodium (Na) or potassium (K), or alkaline earth metals such as magnesium or calcium (Ca), or other light metals such as aluminum. In addition, a lithium metal may be used as an anode active material.

In addition, although the desired ranges of contents of the orthocarbonate ester compound represented by Formula (1) and the cyclic carbonate ester compounds represented by Formulae (2) to (5) in the electrolyte, specific surface area of the anode active material and the volumetric density of the anode active material layer are described in aforementioned embodiments and Examples, the description does not entirely exclude the possibilities outside of these ranges. That is, the desired range is particularly preferred in obtaining the effects of the present disclosure and may be somewhat outside of the range as long as the effects of the present disclosure can be obtained.

It should be understood by those skilled in the art that various modifications, combinations, sub-combinations and alterations may occur depending on design requirements and other factors insofar as they are within the scope of the appended claims or the equivalents thereof.

The invention is claimed as follows:

1. A non-aqueous electrolyte secondary battery comprising:
a cathode;
an anode; and
a non-aqueous electrolyte containing a non-aqueous solvent and an electrolyte salt,
wherein the non-aqueous electrolyte contains an orthocarbonate ester compound represented by Formula (1) and cyclic carbonate ester compounds represented by Formulae (2) to (5). 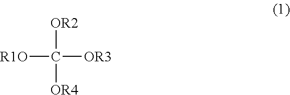
(wherein R1 to R4 each independently represent an alkyl group, an alkyl halide group or an aryl group and R1 to R4 may be joined together to form a ring.) 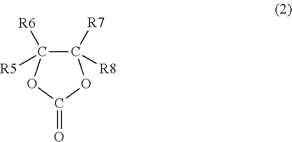
(wherein R5 to R8 each independently represent a hydrogen group, an alkyl group or an alkyl halide group and at least one of R5 to R8 represents a halogen group or an alkyl halide group.) 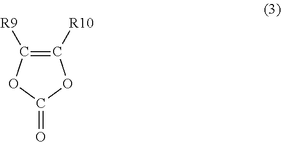
(wherein R9 and R10 each independently represent a hydrogen group, an alkyl group, a halogen group or an alkyl halide group.) 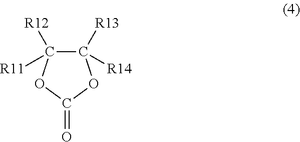
(wherein R11 to R14 each independently represent an alkyl group, a vinyl group or an allyl group and at least one of R11 to R14 represents a vinyl group or an allyl group.) 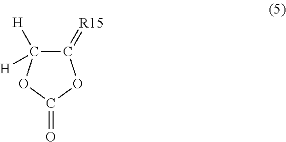
(wherein R15 represents an alkylene group.)

2. The secondary battery according to claim 1, wherein the orthocarbonate ester compound represented by Formula (1) is a compound of Formula (1) in which R1 to R4 are joined together to form a ring.

3. The secondary battery according to claim 1, wherein the orthocarbonate ester compound represented by Formula (1) is an orthocarbonate ester compound represented by Formula (1A). 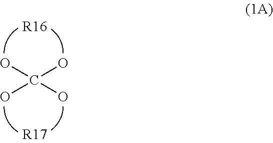
(wherein R16 and R17 each independently represent an alkylene group having two or more carbon atoms, an alkylene halide group having two or more carbon atoms or a divalent aryl group.)

4. The secondary battery according to claim 3, wherein the orthocarbonate ester compound represented by Formula (1A) is a compound of Formula (1A) in which R16 to R17 each independently represent an alkylene group having three or more carbon atoms or an alkylene halide group having three or more carbon atoms.

5. The secondary battery according to claim 1, wherein the content of the orthocarbonate ester compound represented by Formula (1) is 0.01% by mass to 2% by mass, based on the total amount of the non-aqueous electrolyte.

6. The secondary battery according to claim 1, wherein the content of the cyclic carbonate ester compounds represented by Formulae (2) to (5) is 0.5% by mass to 5% by mass, based on the total amount of the non-aqueous electrolyte.

7. The secondary battery according to claim 1, wherein the orthocarbonate ester compound represented by Formula (1) is tetramethyl orthocarbonate, tetraethyl orthocarbonate, tetra-n-propyl orthocarbonate, diethylene orthocarbonate, dipropylene orthocarbonate or dicatechol orthocarbonate,
the cyclic carbonate ester compound represented by Formula (2) is 4-fluoro-1,3-dioxolan-2-one or 4,5-difluoro-1,3-dioxolan-2-one,
the cyclic carbonate ester compound represented by Formula (3) is vinylene carbonate,
the cyclic carbonate ester compound represented by Formula (4) is vinyl ethylene carbonate, and
the cyclic carbonate ester compound represented by Formula (5) is methylene ethylene carbonate.

8. The secondary battery according to claim 1, wherein the non-aqueous electrolyte is a semisolid non-aqueous electrolyte in which an electrolytic solution including the orthocarbonate ester compound represented by Formula (1), the cyclic carbonate ester compounds represented by Formulae (2) to (5), the electrolyte salt and the non-aqueous solvent is held by a polymer compound.

9. The secondary battery according to claim 1, wherein the anode includes an anode active material layer containing a carbon material as an anode active material.

10. The secondary battery according to claim 9, wherein the volumetric density of the anode active material layer is 1.55 g/cc to 1.80 g/cc, and the specific surface area of the carbon material is 0.8 m²/g to 4.0 m²/g.

11. The secondary battery according to claim 1, wherein the electrolyte salt includes at least one selected from the group consisting of lithium hexafluorophosphate, lithium tetrafluoroborate, lithium perchlorate, and lithium hexafluoroarsenate.

12. The secondary battery according to claim 1, wherein an electrode body including the cathode and the anode is housed in a laminate film.

13. A non-aqueous electrolyte comprising:
a non-aqueous solvent;
an electrolyte salt;
an orthocarbonate ester compound represented by Formula (1); and
cyclic carbonate ester compounds represented by Formulae (2) to (5). 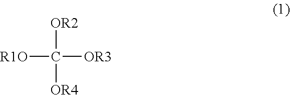
(wherein R1 to R4 each independently represent an alkyl group, an alkyl halide group or an aryl group and R1 to R4 may be joined together to form a ring.) 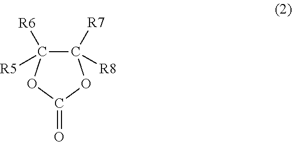
(wherein R5 to R8 each independently represent a hydrogen group, an alkyl group or an alkyl halide group and at least one of R5 to R8 represents a halogen group or an alkyl halide group.) 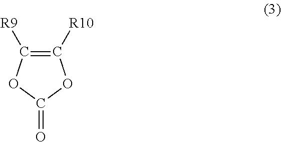
(wherein R9 and R10 each independently represent a hydrogen group, an alkyl group, a halogen group or an alkyl halide group.) 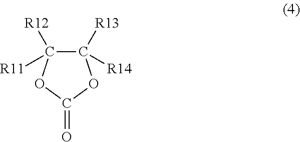
(wherein R11 to R14 each independently represent an alkyl group, a vinyl group or an allyl group and at least one of R11 to R14 represents a vinyl group or an allyl group.) 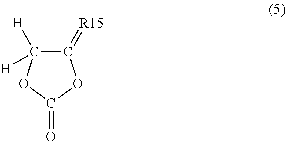
(wherein R15 represents an alkylene group.)
